(19) United States
(12) Patent Application Publication
(10) Pub. No.: US 2010/0225854 A1
(43) Pub. Date: Sep. 9, 2010

(54) LIQUID CRYSTAL PANEL AND LIQUID CRYSTAL DISPLAY APPARATUS USING THE PANEL

(75) Inventors: Ikuo Kawamoto, Ibaraki-shi (JP); Seiji Umemoto, Ibaraki-shi (JP); Takashi Kamijou, Ibaraki-shi (JP); Hideyuki Yonezawa, Ibaraki-shi (JP); Kazuya Hada, Ibaraki-shi (JP); Kentarou Kobayashi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/279,865

(22) PCT Filed: Jan. 26, 2007
(86) PCT No.: PCT/JP2007/051296

§ 371 Date: Mar. 25, 2009

(30) Foreign Application Priority Data
Feb. 20, 2006 (JP) 2006-042823
Jul. 6, 2006 (JP) 2006-186832

(51) Int. Cl. G02F 1/1335

(52) U.S. Cl. 349/96; 349/119

(57) ABSTRACT

Provided are a liquid crystal panel which contributes to reduction in thickness and is excellent in optical properties and a liquid crystal display apparatus. The liquid crystal panel of the present invention includes a liquid crystal cell, a first polarizer disposed on one side of the liquid crystal cell, a second polarizer disposed on another side of the liquid crystal cell, a first optical compensation layer and a first negative C plate disposed between the first polarizer and the liquid crystal cell, and a second negative C plate and a second optical compensation layer disposed between the liquid crystal cell and the second polarizer, in which the first optical compensation layer is disposed between the first polarizer and the first negative C plate, the second optical compensation layer is disposed between the second negative C plate and the second polarizer, the first and second optical compensation layers each include a coating layer functioning as a λ/4 plate, and each have a thickness of 0.3 to 3 μm, and the first and second negative C plates each include a coating layer, and each have a thickness of 0.5 to 10 μm.

### TECHNICAL FIELD

The present invention relates to a liquid crystal panel and a liquid crystal display apparatus using the panel, and more specifically, to a liquid crystal panel and a liquid crystal display apparatus each of which: contributes to a reduction in thickness; has a wide band, a wide view angle, and a suppressed color shift; achieves good color reproducibility; and is capable of favorably preventing light leakage in black display.

### BACKGROUND ART

There is proposed a semi-transmissive reflective liquid crystal display apparatus as a liquid crystal display apparatus of VA mode, in addition to a transmissive liquid crystal display apparatus and a reflective liquid crystal display apparatus (see Patent Documents 1 and 2, for example). The semi-transmissive reflective liquid crystal display apparatus utilizes outside light in the same manner as in the reflective liquid crystal display apparatus in a bright place, and allows visualization of display with an internal light source such as backlight in a dark place. That is, the semi-transmissive reflective liquid crystal display apparatus employs a display system combining reflective mode and transmissive mode, and switches display mode to reflective mode or transmissive mode in accordance with brightness of its environment. As a result, the semi-transmissive reflective liquid crystal display apparatus can provide a clear display even in a dark environment while reducing power consumption, and thus is suitably used for a display part of a portable device. However, those liquid crystal display apparatuses according to the VA mode, in particular, semi-transparent liquid crystal display apparatuses each involve the following problem: light leakage in black display occurs, so a contrast reduces. The problem has remained unsolved for a long time period.

Various attempts have been made to solve the above-mentioned problem, and the attempts each relate to the optimization of the optical characteristics of a retardation plate and/or the disposal of the plate in a liquid crystal display apparatus for the acquisition of optimum optical compensation (such as an improvement in view angle characteristic, the alleviation of a color shift, or an improvement in contrast). For example, liquid crystal display apparatuses as described in Patent Documents 3 and 4 have been proposed. The liquid crystal display apparatuses each have: a first optical compensation plate arranged on each of both sides of a liquid crystal cell; a second optical compensation plate arranged outside the first optical compensation plate; and a polarizing plate arranged outside the second optical compensation plate. However, the thickness of each of the first optical compensation plate and the second optical compensation plate to be used in any such liquid crystal display apparatus is 50 μm or more, so it is extremely difficult to reduce the thickness of the liquid crystal display apparatus.

Meanwhile, technologies each intended to compensate for the influences of the birefringence of a liquid crystal molecule and the axial shift of a polarizing plate on light leakage with a biaxial optical compensation plate have been proposed in order that the thickness of a liquid crystal display apparatus may be reduced, and optimum optical compensation may be obtained. However, any one of those technologies is insufficient for an improvement in view angle characteristic, though any one of the technologies contributes to a reduction in thickness of the liquid crystal display apparatus.

As described above, a liquid crystal display apparatus (liquid crystal panel) capable of satisfying needs for additionally excellent display quality and an additionally small thickness has been strongly demanded.

Patent Document 1: JP 11-242226 A

Patent Document 2: JP 2001-209065 A

Patent Document 3: JP 2002-303869 A

Patent Document 4: JP 2002-55342 A

### DISCLOSURE OF THE INVENTION

### Problems to be Solved by the Invention

The present invention has been made with a view toward solving the above-mentioned conventional problems, and an object of the present invention is to provide a liquid crystal panel and a liquid crystal display apparatus each of which: contributes to a reduction in thickness; has a wide band, a wide view angle, and a suppressed color shift; achieves good color reproducibility; and is capable of favorably preventing light leakage in black display.

### Means for Solving the Problems

The liquid crystal panel of the present invention includes a liquid crystal cell, a first polarizer disposed on one side of the liquid crystal cell, a second polarizer disposed on another side of the liquid crystal cell, a first optical compensation layer and a first negative C plate disposed between the first polarizer and the liquid crystal cell, and a second negative C plate and a second optical compensation layer disposed between the liquid crystal cell and the second polarizer. The first optical compensation layer is disposed between the first polarizer and the first negative C plate and the second optical compensation layer is disposed between the second negative C plate and the second polarizer. The first optical compensation layer and the second optical compensation layer each include a coating layer functioning as a λ/4 plate, and each have a thickness of 0.3 to 3 μm. The first negative C plate and the second negative C plate each include a coating layer, and each have a thickness of 0.5 to 10 μm.

In a preferred embodiment, the first negative C plate includes a cholesteric alignment fixed layer. In another preferred embodiment, the first negative C plate includes a coating layer including at least one kind of non-liquid crystal polymer selected from the group consisting of polyamide, polyimide, polyester, polyetherketone, polyamideimide, and polyesterimide.

In the preferred embodiment, the second negative C plate includes a cholesteric alignment fixed layer. In the another preferred embodiment, the second negative C plate includes a coating layer including at least one kind of non-liquid crystal polymer selected from the group consisting of polyamide, polyimide, polyester, polyetherketone, polyamideimide, and polyesterimide.

In the preferred embodiment, a slow axis of the first optical compensation layer defines an angle of +40° to +50° or −40° to −50° with respect to an absorption axis of the first polarizer.

In the preferred embodiment, a slow axis of the second optical compensation layer defines an angle of +40° to +50° or −40° to −50° with respect to an absorption axis of the second polarizer.

In the preferred embodiment, a protective layer is further provided on at least one side of the first polarizer.

In the preferred embodiment, a protective layer is further provided on at least one side of the second polarizer.

In the preferred embodiment, the first optical compensation layer and the first negative C plate are disposed through a first adhesion layer.

In the preferred embodiment, the second optical compensation layer and the second negative C plate are disposed through a second adhesion layer.

In the preferred embodiment, the liquid crystal cell is a VA mode of a transmission function or a semi-transmission function.

According to another aspect of the present invention, a liquid crystal display apparatus is provided. The liquid crystal display apparatus includes the above liquid crystal panel.

### EFFECTS OF THE INVENTION

As described above, according to the present invention, all of the specific optical compensation layers and the specific negative C plates disposed on both sides of the liquid crystal cell are coating layers, whereby the present invention can contribute to a reduction in thickness of a liquid crystal panel (liquid crystal display apparatus) as compared to the conventional technology. Further, the liquid crystal panel of the present invention has the specific optical compensation layers and the specific negative C plates, so a liquid crystal panel having a wide band and a wide view angle can be obtained, and a reduction in contrast due to light leakage in black display can be significantly alleviated particularly in a liquid crystal display apparatus of a VA mode. In a preferred embodiment, the optical compensation layers disposed on both sides of the liquid crystal cell have the same characteristics (such as components, optical properties, and a thickness), and the negative C plates disposed on both sides of the liquid crystal cell have the same characteristics (such as components, optical properties, and a thickness). Such symmetric placement can additionally reduce a color shift.

### BRIEF DESCRIPTION OF THE DRAWINGS

FIG. 1 is an outline sectional view of a liquid crystal panel in a preferred embodiment of the present invention.

FIG. 2 is an outline exploded perspective view of the liquid crystal panel in the preferred embodiment of the present invention.

FIG. 3 is an outline exploded perspective view of a liquid crystal panel in another preferred embodiment of the present invention.

FIG. 4 are each an outline sectional view for explaining an alignment state of a liquid crystal molecule of a liquid crystal layer when a liquid crystal display apparatus of the present invention adopts a liquid crystal cell of a VA mode.

FIG. 5 is a perspective view showing an outline of one step in an example of a method of producing a liquid crystal panel of the present invention.

FIG. 6 is a schematic view showing an outline of another step in an example of a method of producing an elliptical polarizing plate of the present invention.

FIG. 7 is a perspective view showing an outline of another step in the example of the method of producing a liquid crystal panel of the present invention.

FIG. 8 are each a schematic view showing an outline of another step in the example of the method of producing an elliptical polarizing plate of the present invention.

FIG. 9 are each a schematic view showing an outline of another step in the example of the method of producing an elliptical polarizing plate of the present invention.

FIG. 10 is a perspective view showing an outline constitution of a rubbing treatment apparatus.

FIG. 11(a) is a front view showing a vicinity of a rubbing roll, and FIG. 11(b) is an enlarged front view showing a vicinity of a portion where the rubbing roll and a surface of a continuous substrate film are in contact with each other.

FIG. 12 are each a sample photograph for evaluation for a rubbing stripe level.

### DESCRIPTION OF REFERENCE NUMERALS

1, 2 driving roll
3 conveying belt
4 rubbing roll
4a raised fabric
5 back-up roll
F continuous substrate film
11, 12 polarizer
21, 22 optical compensation layer
31, 32 negative c plate
40 liquid crystal cell
100 liquid crystal display apparatus

### DETAILED DESCRIPTION OF PREFERRED EMBODIMENT

### Definitions of Terms and Symbols

Definitions of terms and symbols in the specification of the present invention are described below.

(1) The symbol “nx” refers to a refractive index in a direction providing a maximum in-plane refractive index (that is, a slow axis direction), and the symbol “ny” refers to a refractive index in a direction perpendicular to the slow axis in the same plane (that is, a fast axis direction). The symbol “nz” refers to a refractive index in a thickness direction. Further, the expression “nx=ny”, for example, not only refers to the case where nx and ny are exactly equal but also includes the case where nx and ny are substantially equal. In the specification of the present invention, the phrase “substantially equal” includes the case where nx and ny differ within a range providing no effects on overall polarization properties of a polarizing plate provided with optical compensation layers in practical use.
(2) The term “in-plane retardation Re” refers to an in-plane retardation value of a film (layer) measured at 23° C. by using light of a wavelength of 590 nm. Re can be determined from an equation Re=(nx−ny)×d, where nx and ny represent refractive indices of a film (layer) at a wavelength of 590 nm in a slow axis direction and a fast axis direction, respectively, and d (nm) represents a thickness of the film (layer).
(3) The term “thickness direction retardation Rth” refers to a thickness direstion retardation value measured at 23° C. by using light of a wavelength of 590 nm. Rth can be determined from an equation Rth=(nx−nz)×d, where nx and nz represent refractive indices of a film (layer) at a wavelength of 590 nm in a slow axis direction and a thickness direction, respectively, and d (nm) represents a thickness of the film (layer).
(4) The subscript “1” attached to a term or symbol described in the specification of the present invention represents a first optical compensation layer. The subscript “2” attached to a term or symbol described in the specification of the present invention represents a second optical compensation layer. The subscript “C” attached to a term or symbol described in the specification of the present invention represents a negative C plate. The subscript “1C” attached to a term or symbol described in the specification of the present invention represents a first negative C plate. The subscript “2C” attached to a term or symbol described in the specification of the present invention represents a second negative C plate.
(5) The term “λ/4 plate” refers to a plate having a function of converting linearly polarized light of a specific wavelength into circularly polarized light (or converting circularly polarized light into linearly polarized light). The λ/4 plate has an in-plane retardation value of a film (layer) of about ¼ of a predetermined light wavelength (generally, visible light region).
(6) The term “cholesteric alignment fixed layer” refers to a layer in which: molecules forming the layer form a helical structure; a helical axis of the helical structure is aligned substantially perpendicular to a plane direction; and an alignment state is fixed. Thus, the term “cholesteric alignment fixed layer” not only refers to the case where liquid crystal compound exhibits a cholesteric liquid crystal phase, but also includes the case where a non-liquid crystal compound has a pseudo structure of a cholesteric liquid crystal phase. For example, the “cholesteric alignment fixed layer” may be formed by: providing torsion to a liquid crystal material exhibiting a liquid crystal phase with a chiral agent for alignment into a cholesteric structure (helical structure); subjecting the liquid crystal material to polymerization treatment or crosslinking treatment for fixing the alignment (cholesteric structure) of the liquid crystal material.
(7) The phrase “selective reflection wavelength region of 350 nm or less” indicates that a center wavelength λ of a selective reflection wavelength region is 350 nm or less. For example, in the case where the cholesteric alignment fixed layer is formed by using a liquid crystal monomer, the center wavelength λ of the selective reflection wavelength region may be represented by the following equation.

λ=n×P

In the equation, n represents an average refractive index of the liquid crystal monomer, and P represents a helical pitch (nm) of the cholesteric alignment fixed layer. The average refractive index n is represented by (nₒ+nₑ)/2, and is generally within a range of 1.45 to 1.65. nₒ represents an ordinary refractive index of the liquid crystal monomer, and nₑ represents an extraordinary refractive index of the liquid crystal monomer.
(8) The term “chiral agent” refers to a compound having a function of aligning the liquid crystal material (nematic liquid crystals, for example) into a cholesteric structure.
(9) The term “torsional force” refers to ability of the chiral agent to provide torsion to the liquid crystal material and to align the liquid crystal material into a cholesteric structure (helical structure). In general, the torsional force may be represented by the following equation.

Torsional force=1/(P×W)

As described above, P represents a helical pitch (nm) of the cholesteric alignment fixed layer. W represents a weight ratio of the chiral agent. The weight ratio of the chiral agent may be represented by W=[X/(X+Y)]×100. X represents a weight of the chiral agent, and Y represents a weight of the liquid crystal material.

(10) The phrase “substantially vertical” includes a case where a predetermined angle is 90°±10°, preferably 90°±5°, and more preferably 90°±3°.
(11) The phrase “substantially parallel” includes a case where a predetermined angle is 0°±10°, preferably 0°±5°, and more preferably 0°±3°.

### A. Entire Constitution of Liquid Crystal Panel

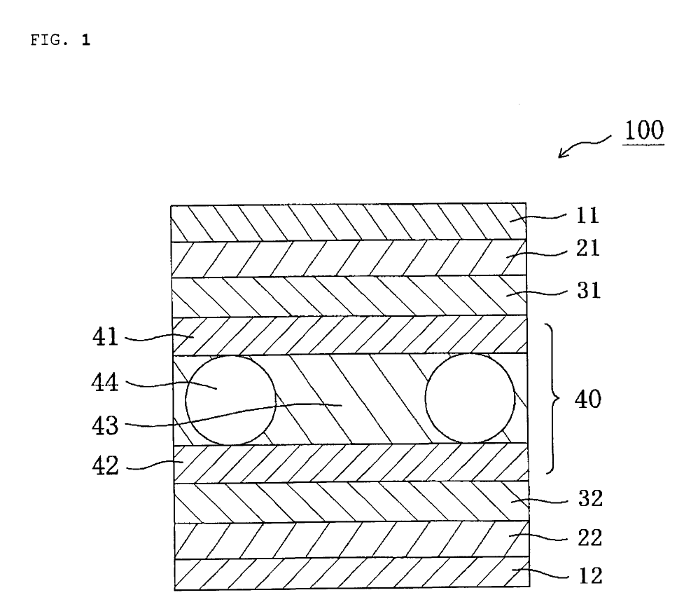

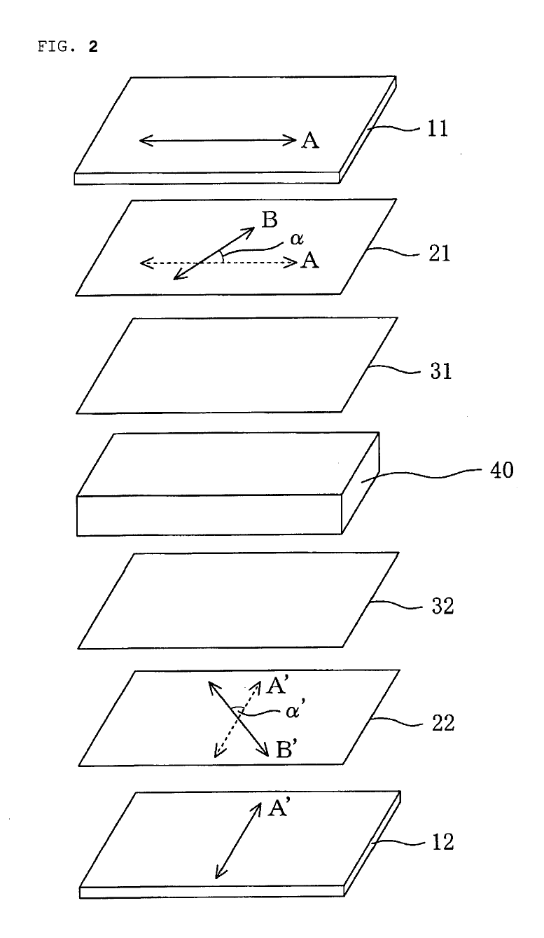

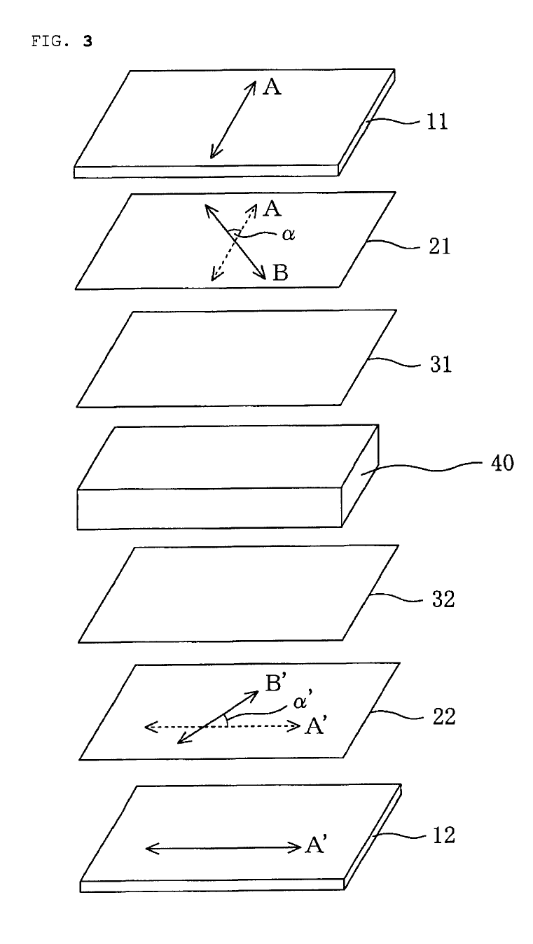

FIG. 1 is an outline sectional view of a liquid crystal panel according to a preferred embodiment of the present invention. FIGS. 2 and 3 are each an outline exploded perspective view of the liquid crystal panel in the preferred embodiment of the present invention. It should be noted that, in each of FIGS. 2 and 3, reference symbol A represents the absorption axis of a first polarizer; B, the slow axis of a first optical compensation layer; and a, an angle specified by the absorption axis A of the first polarizer and the slow axis B of the first optical compensation layer. In the same manner as that described above, in each of FIGS. 2 and 3, reference symbol A′ represents the absorption axis of a second polarizer; B′, the slow axis of a second optical compensation layer; and α′, an angle specified by the absorption axis A′ of the second polarizer and the slow axis B′ of the second optical compensation layer. In the example shown in FIG. 1, a liquid crystal panel 100 has a first polarizer 11, a first optical compensation layer 21, a first negative C plate 31, a liquid crystal cell 40, a second negative C plate 32, a second optical compensation layer 22, and a second polarizer 12 in the stated order from its viewer side.

The first polarizer 11 and the second polarizer 12 are typically arranged so that their absorption axes are substantially perpendicular to each other.

The direction of the absorption axis of the first polarizer can be appropriately set depending on purposes. For example, the direction of the absorption axis of the first polarizer arranged on the viewer side of the liquid crystal cell may be substantially parallel to the longitudinal direction of the liquid crystal cell (in this case, the direction of the absorption axis of the second polarizer is perpendicular to the longitudinal direction of the liquid crystal cell; see FIG. 2), or may be substantially perpendicular to the longitudinal direction of the liquid crystal cell (in this case, the direction of the absorption axis of the second polarizer is parallel to the longitudinal direction of the liquid crystal cell; see FIG. 3).

The above first optical compensation layer 21 and the above second optical compensation layer 22 are each a coating layer functioning as a λ/4 plate, and each have a thickness of 0.3 to 3 μm. The slow axis of the first optical compensation layer 21 (B in each of FIGS. 2 and 3, the same holds true for the following) preferably defines an angle of +40° to +50° or −40° to −50° with respect to the absorption axis A of the first polarizer 11. The slow axis B of the second optical compensation layer 22 preferably defines an angle of +40° to +50° or −40° to −50° with respect to the absorption axis A′ of the second polarizer 12. The first optical compensation layer 21 and the second optical compensation layer 22 are typically arranged so that their slow axes are substantially perpendicular to each other. The first optical compensation layer and the second optical compensation layer may be the same coating layers, or may be different coating layers. The first optical compensation layer and the second optical compensation layer preferably have the same characteristics (such as components, optical characteristics, and a thickness). Such symmetric disposal can additionally reduce a color shift. The first negative C plate 31 and the second negative C plate 32 are each a coating layer, and each have a thickness of 0.5 to 10 μm. At least one of the first negative C plate and the second negative C plate is preferably composed of a cholesteric alignment fixed layer. The first optical compensation layer 21 and the first negative C plate 31 are preferably arranged through a first adhesion layer (not shown), and the second optical compensation layer 22 and the second negative C plate 32 are preferably arranged through a second adhesion layer (not shown). The first negative C plate and the second negative C plate may be the same coating layers, or may be different coating layers. The first negative C plate and the second negative C plate preferably have the same characteristics (such as components, optical characteristics, and a thickness). Such symmetric disposal can additionally reduce a color shift.

It is preferred that a first protective layer (not shown) be provided between the first polarizer 11 and the first optical compensation layer 21 and a second protective layer (not shown) be provided between the second optical compensation layer 22 and the second polarizer 12. Further, for practical use, another protective layer (not shown) is provided on a side of the first polarizer 11, which is opposite to the first optical compensation layer 21 (outer side of the first polarizer 11, a viewer side in shown example), and another protective layer (not shown) is provided on a side of the second polarizer 12, which is opposite to the second optical compensation layer 22 (outer side of the second polarizer 12, a backlight side in shown example).

The liquid crystal cell 40 includes: a pair of glass substrates 41 and 42; and a liquid crystal layer 43 as a display medium arranged between the substrates. One substrate (active matrix substrate) 42 is provided with: a switching element (typically, TFT) for controlling electrooptic properties of liquid crystals; and a scanning line for providing a gate signal to the switching element and a signal line for providing a source signal thereto (the lines not shown). The other glass substrate (color filter substrate) 41 is provided with a color filter (now shown). Note that the color filter may be provided in the active matrix substrate 42 as well. A distance (cell gap) between the substrates 41 and 42 is controlled by a spacer 44. An aligned film (not shown) formed of polyimide, for example, is provided on a side of each of the substrates 41 and 42 in contact with the liquid crystal layer 43.

Any appropriate drive mode can be employed for drive mode of the liquid crystal cell 40 as long as effects of the present invention can be obtained. Specific examples of the drive mode include STN (Super Twisted Nematic) mode, TN (Twisted Nematic) mode, IPS (In-Plane Switching) mode, VA (Vertical Aligned) mode, OCB (OpticallyAlignedBirefringence) mode, HAN (HybridAlignedNematic) mode, and ASM (Axially Symmetric Aligned Microcell) mode. The VA mode is preferred, and the transmissive or semi-transmissive VA mode is more preferred.

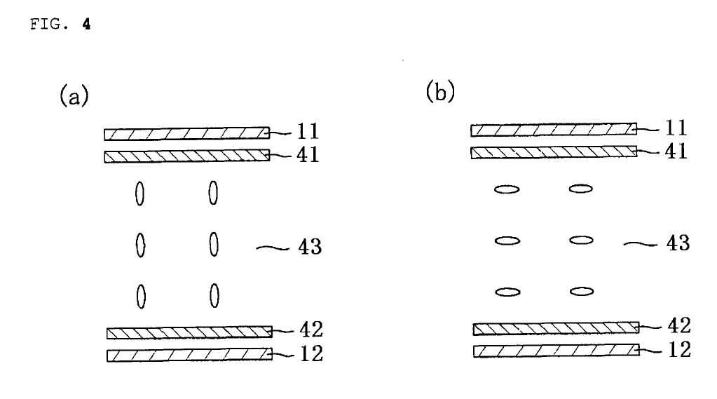

FIG. 4 are each a schematic sectional view explaining an alignment state of liquid crystal molecules in VA mode. As shown in FIG. 4(a), the liquid crystal molecules are aligned vertically to surfaces of the substrates 41 and 42 under no voltage application. Such vertical alignment may be realized by arranging nematic liquid crystals having negative dielectric anisotropy between substrates each having formed thereon a vertically aligned film (not shown). Light enters from a surface of one substrate 41 in such a state, and linear polarized light allowed to pass through the first polarizer 11 and to enter the liquid crystal layer 43 advances along long axes of vertically aligned liquid crystal molecules. No birefringence generates in a long axis direction of the liquid crystal molecules such that incident light advances without changing a polarization direction and is absorbed by the second polarizer 12 having a polarization axis perpendicular to the first polarizer 11. In this way, dark display is obtained under no voltage application (normally black mode). As shown in FIG. 4(b), long axes of the liquid crystal molecules align parallel to the surfaces of the substrates under voltage application between electrodes. The liquid crystal molecules exhibit birefringence with respect to linear polarized light entering the liquid crystal layer 43 in such a state, and a polarization state of incident light varies depending on inclination of the liquid crystal molecules. Light allowed to pass through the liquid crystal layer under application of a predetermined maximum voltage rotates its polarization direction by 90°, for example, into linear polarized light and passes through the second polarizer 12, to thereby provide light display. Return to a state under no voltage application provides dark display again by alignment control force. The inclination of the liquid crystal molecules is controlled by varying an application voltage. Therefore, an intensity of transmitted light from the second polarizer 12 may change, to thereby provide gradient display.

Hereinafter, details on the respective layers of which the liquid crystal panel in the present invention is constituted will be described.

### B. First and Second Optical Compensation Layers

As described above, the first optical compensation layer and the second optical compensation layer (which may hereinafter be collectively described as “optical compensation layers”) are each a coating layer functioning as a λ/4 plate, and each have a thickness of 0.3 to 3 μm. The optical compensation layers each have a thickness of preferably 0.5 to 2.5 μm, or more preferably 0.8 to 2 μm. Since the optical compensation layers (λ/4 plates) are each a coating layer, the thickness of each of the layers can be markedly reduced as compared to a conventional thickness, so the layers can greatly contribute to a reduction in thickness of the liquid crystal panel in the present invention. For example, a λ/4 plate based on a conventional stretched film has a thickness of about 60 μm, but each of the optical compensation layers in the present invention can realize a thickness about one twentieth to one two-hundredth of the above thickness.

The slow axis B of the first optical compensation layer can preferably define an angle α of +40° to +50° or −40° to −50° with respect to the absorption axis A of the first polarizer. The slow axis B of the first optical compensation layer defines an angle α of preferably +42° to +48° or −42° to −48°, or more preferably +44° to +46° or −44° to −46° with respect to the absorption axis A of the first polarizer. Placing the polarizer and the optical compensation layer in such specific positional relationship can provide a liquid crystal panel excellent in balance between a contrast and a view angle characteristic.

The slow axis B′ of the second optical compensation layer preferably defines an angle α′ of +40° to +50° or −40° to −50° with respect to the absorption axis A′ of the second polarizer. The slow axis B′ of the second optical compensation layer defines an angle α′ of preferably +42° to +48° or −42° to −48°, or more preferably +44° to +46° or −44° to −46° with respect to the absorption axis A′ of the second polarizer. Placing the polarizer and the optical compensation layer in such specific positional relationship can provide a liquid crystal panel excellent in balance between a contrast and a view angle characteristic.

The first optical compensation layer and the second optical compensation layer are preferably arranged so that their slow axes are substantially perpendicular to each other. Placing the optical compensation layers in such specific positional relationship can provide optimum optical compensation.

As described above, each of the first and second optical compensation layers can function as the so-called λ/4 plate. Each of an in-plane retardation Re₁ of the first optical compensation layer and an in-plane retardation Re₂ of the second optical compensation layer is preferably 80 to 200 nm, more preferably 100 to 180 nm, or most preferably 120 to 160 nm at a wavelength of 590 nm. The first and second optical compensation layers each preferably have a refractive index distribution of nx>ny=nz.

Any appropriate and proper material can be adopted as a material of which each of the above first and second optical compensation layers is formed as long as such characteristics as described above can be obtained. Each of the above optical compensation layers is preferably formed of a liquid crystal material. The use of the liquid crystal material can markedly increase a difference between nx and ny as compared to that of a conventional polymer stretched film (such as a norbornene-based resin or a polycarbonate resin), so a thickness for obtaining a desired in-plane retardation for a λ/4 plate can be markedly reduced. For example, a liquid crystal polymer or a liquid crystal monomer can be used as such liquid crystal material. The mechanism via which the liquid crystal material expresses liquid crystallinity may be lyotropic or thermotropic. In addition, the alignment state of liquid crystal is preferably homogeneous alignment. One kind of a liquid crystal material may be used alone, or two or more kinds of liquid crystal materials may be used in combination.

A liquid crystal monomer used as the liquid crystal material is preferably a polymerizable monomer and/or a crosslinking monomer, for example. As described below, this is because the alignment state of the liquid crystal material can be fixed by polymerizing or crosslinking the polymerizable monomer or the crosslinking monomer. The alignment state of the liquid crystal monomer can be fixed by aligning the liquid crystal monomer, and then polymerizing or crosslinking the liquid crystal monomers (the polymerizable monomer or the crosslinking monomer), for example. A polymer is formed through polymerization, and a three-dimensional network structure is formed through crosslinking. However, the polymer and the three-dimensional network structure exhibit non-liquid crystallinity. Thus, the formed optical compensation layer will not undergo phase transition into a liquid crystal phase, a glass phase, or a crystal phase by change in temperature, which is specific to a liquid crystal material. As a result, the optical compensation layer has excellent stability and is not affected by change in temperature.

Any suitable liquid crystal monomers may be employed as the liquid crystal monomer. For example, there are used polymerizable mesogenic compounds and the like described in JP 2002-533742 A (WO 00/37585), EP358208 (U.S. Pat. No. 5,211,877), EP 66137 (U.S. Pat. No. 4,388,453), WO 93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

The above liquid crystal monomer is preferably, for example, a nematic liquid crystal monomer. Specific examples of the liquid crystal monomer include monomers described in the paragraphs (0035) to (0046) of JP-A-2003-287623. One kind of those liquid crystal monomers can be used alone, or two or more kinds of them can be used in combination.

The temperature range in which the above liquid crystal monomer shows liquid crystallinity varies depending on the kind of the liquid crystal monomer. To be specific, the temperature range is preferably 40 to 120° C., more preferably 50 to 100° C., or most preferably 60 to 90° C.

The liquid crystal material contains at least one of a polymerization initiator and a cross-linking agent (curing agent) as required. Those are particularly preferably used when using a liquid crystal monomer as the liquid crystal material. Any appropriate substance may be used for the polymerization initiator or the cross-linking agent as long as the effect of the present invention can be obtained. Examples of the polymerization initiator include benzoylperoxide (BPO) and azobisisobutyronitrile (AIBN). Examples of the cross-linking agent (curing agent) include a ultraviolet-curing agent, a photo-curing agent, and a heat-curing agent. Specific examples thereof include an isocyanate-based cross-linking agent, an epoxy-based cross-linking agent, and a metal chelate cross-linking agent. One kind of polymerization initiator or cross-linking agent may be used alone, or two or more kinds of them may be used in combination. A content of the polymerization initiator or the cross-linking agent in the liquid crystal material is preferably 0.1 to 10 wt %, more preferably 0.5 to 8 wt %, and most preferably 1 to 5 wt %.

The liquid crystal material may contain another appropriate additive as required. Examples of the additive include an antioxidant, a modifier, a surfactant, a dye, a pigment, a color protection agent, and a ultraviolet absorber. One kind of additive may be used alone, or two or more kinds of them may be used in combination. Specific examples of the antioxidant include a phenol-based compound, an amine-based compound, an organic sulfur-based compound, and a phosphine-based compound. Examples of the modifier include glycols, silicones, and alcohols. The surfactant is added for smoothing a surface of the optical compensation layer. Examples of the surfactant that can be used include a silicone-based surfactant, an acrylic surfactant, and a fluorine-based surfactant.

### C. First and Second Negative C Plates

The above first and second negative C plates (which may hereinafter be collectively described as “negative C plates”) are each a coating layer, and each have a thickness of 0.5 to 10 μm. The negative C plates each have a thickness of preferably 1.0 to 8 μm, or more preferably 1.5 to 5 μm. As described above, the negative C plates in the present invention each have a small thickness, so the plates can greatly contribute to a reduction in thickness of the liquid crystal panel. Forming the negative C plates so that the plates each have a small thickness can prevent heat unevenness. Further, such thin negative C plates are preferred from the viewpoints of, for example, the prevention of the disturbance of liquid crystal alignment and the prevention of a reduction in transmittance, selective reflecting property, the prevention of coloring, and productivity.

The negative C plates each have the relationship of nx=ny>nz. When the negative C plates each have such refractive index distribution, the birefringence of the liquid crystal layer of a liquid crystal cell according to, in particular, a VA mode can be favorably compensated. To be more specific, each of the negative C plates is used for preventing the deterioration of a view angle characteristic as a result of the breaking of isotropy due to an influence of a liquid crystal molecule in a liquid crystal display apparatus of a vertical aligned mode (VA mode) when the apparatus is observed from an oblique direction. As a result, a liquid crystal display apparatus with a significantly improved view angle characteristic can be obtained.

In the description, the relationship “nx=ny” includes not only the case where nx and ny are strictly equal to each other but also the case where nx and ny are substantially equal to each other, so the first and second negative C plates can have in-plane retardations Re_{1C} and Re_{2C}, respectively, and can have slow axes. Each of the in-plane retardations Re_{1C} and Re_{2C} practically allowable in the negative C plates is preferably 0 to 20 nm, more preferably 0 to 10 nm, or most preferably 0 to 5 nm. Each of a thickness direction retardation Rth_{1C} of the first negative C plate and a thickness direction retardation Rth_{2C} of the second negative C plate is preferably 30 to 300 nm, more preferably 60 to 180 nm, particularly preferably 80 to 150 nm, or most preferably 100 to 140 nm.

The negative C plates in the present invention are each formed of any appropriate and proper coating layer as long as such thickness and optical characteristics as described above can be obtained. A preferred example of such layer is a cholesteric alignment fixed layer.

Preferably, the above cholesteric alignment fixed layer is formed of a cholesteric alignment fixed layer having a selective reflection wavelength region of 350 nm or less. An upper limit of the selective reflection wavelength region is more preferably 320 nm or less, and most preferably 300 nm or less. Meanwhile, a lower limit of the selective reflection wavelength region is preferably 100 nm or more, and more preferably 150 nm or more. In the case where the selective reflection wavelength region is more than 350 nm, the selective reflection wavelength region covers a visible light region and thus may cause a problem such as coloring or decoloring. In the case where the selective reflection wavelength region is less than 100 nm, amount of a chiral agent (described below) to be used increases excessively and thus a temperature during formation of the negative C plate must be controlled very accurately. As a result, a liquid crystal panel may hardly be produced.

A helical pitch in the cholesteric alignment fixed layer is preferably 0.01 to 0.25 μm, more preferably 0.03 to 0.20 μm, and most preferably 0.05 to 0.15 μm. A helical pitch of 0.01 μm or more provides sufficient alignment property, for example. A helical pitch of 0.25 μm or less allows sufficient suppression of rotary polarization in a shorter wavelength side of visible light, for example, to thereby sufficiently prevent light leak and the like. The helical pitch may be controlled by adjusting the type (torsional force) and amount of the chiral agent as described below. The helical pitch may be adjusted, to thereby control the selective reflection wavelength region within a desired range.

The negative C plates in the present invention are each formed of any appropriate and proper material as long as such thickness and optical characteristics as described above can be obtained when the negative C plates are each a cholesteric alignment fixed layer. Each of the plates can preferably be formed of a liquid crystal material, or more preferably a liquid crystal composition containing a liquid crystal material and a chiral agent. Any appropriate and proper liquid crystal material can be adopted as the liquid crystal material. A liquid crystal material the liquid crystal phase of which is a nematic phase (nematic liquid crystal) is preferred. For example, a liquid crystal polymer or a liquid crystal monomer can be used as such liquid crystal material. The mechanism via which the liquid crystal material expresses liquid crystallinity may be lyotropic or thermotropic. In addition, the alignment state of liquid crystal is preferably homogeneous alignment.

The content of the liquid crystal material in the above liquid crystal composition is preferably 75 to 95 wt %, or more preferably 80 to 90 wt %. When the content of the liquid crystal material is less than 75 wt %, the composition does not sufficiently present a liquid crystal state, with the result that cholesteric alignment is not sufficiently formed in some cases. When the content of the liquid crystal material exceeds 95 wt %, the content of the chiral agent reduces, and distortion is not sufficiently provided, so cholesteric alignment is not sufficiently formed in some cases.

The above liquid crystal material is preferably a liquid crystal monomer (such as a polymerizable monomer or a cross-linking monomer). Any appropriate and proper liquid crystal monomer can be adopted as the liquid crystal monomer. As in the case of the above section B, specific examples of the liquid crystal monomer include monomers described in the paragraphs (0035) to (0046) of JP-A-2003-287623. One kind of those liquid crystal monomers can be used alone, or two or more kinds of them can be used in combination.

The liquid crystal composition of which each of the negative C plates can be formed preferably contains a chiral agent. Forming each of the negative C plates from a liquid crystal composition containing a liquid crystal monomer and a chiral agent can markedly increase a difference between nx and nz (nx>>nz). As a result, each of the negative C plates can be made thin. For example, a conventional biaxially stretched negative C plate has a thickness of 60 μm or more, but each of the negative C plates in the present invention can realize a thickness of about one sixth to one one-hundred twentieth of the above thickness. As a result, the plates can greatly contribute to a reduction in thickness of the liquid crystal panel.

A content of the chiral agent in the liquid crystal composition is preferably 5 to 23 wt %, and more preferably 10 to 20 wt %. In the case where the content of the chiral agent is less than 5 wt %, torsion cannot be sufficiently provided and thus the cholesteric alignment may not be formed sufficiently. In the case where the content of the chiral agent is more than 23 wt %, the liquid crystal material exhibits a liquid crystal state in a very narrow temperature range and a temperature during formation of a negative C plate must be controlled very accurately. As a result, production of a negative C plate may involve difficulties. Note that one type of chiral agent may be used alone, or two or more types thereof may be used in combination.

The chiral agent may employ any appropriate material capable of aligning the liquid crystal material into a desired cholesteric structure. For example, such a chiral agent has a torsional force of preferably 1×10⁻⁶ nm⁻¹·(wt %)⁻¹ or more, more preferably 1×10⁻⁵ nm⁻¹·(wt %)⁻¹ to 1×10⁻²nm⁻·(wt%)⁻¹, and most preferably 1×10⁻⁴ nm⁻¹·(wt %)⁻¹ to 1×10⁻³ nm⁻¹·(wt %)⁻¹. A chiral agent having such a torsional force may be used, to thereby control a helical pitch of the cholesteric alignment fixed layer within a desired range and control the selective reflection wavelength region within a desired range. For example, in the case where chiral agents of equal torsional force are used, a larger content of the chiral agent in the liquid crystal composition provides a negative C plate having a selective reflection wavelength region on a shorter wavelength side. For example, in the case where the content of the chiral agent in the liquid crystal composition is equal, a chiral agent having a larger torsional force provides a negative C plate having a selective reflection wavelength region on a shorter wavelength side. A specific example thereof is described below. For setting the selective reflection wavelength region of the negative C plate to be formed within a range of 200 to 220 nm, a liquid crystal composition may contain 11 to 13 wt % of a chiral agent having a torsional force of 5×10⁻⁴ nm⁻¹·(wt %) for example. For setting the selective reflection wavelength region of the negative C plate to be formed within a range of 290 to 310 nm, a liquid crystal composition may contain 7 to 9 wt % of a chiral agent having a torsional force of 5×10⁻⁴ nm⁻¹·(wt %)⁻¹, for, example.

The above chiral agent is preferably a polymerizable chiral agent. Specific examples of the polymerizable chiral agent include chiral agents described in the paragraphs (0048) to (0055) of JP-A-2003-287623.

In addition to such chiral compounds as described above, chiral compounds described in, for example, RE-A 4342280, German Patent Application No. 19520660.6, and German Patent Application No. 19520704.1 can be preferably used.

It should be noted that any appropriate and proper combination can be adopted as a combination of the above liquid crystal material and the above chiral agent depending on purposes. Examples of a particularly preferred combination include: a combination of a liquid crystal monomer represented by the following formula (1) and a chiral agent represented by the following formula (3); a combination of the liquid crystal monomer represented by the following formula (1) and a chiral agent represented by the following formula (4); and a combination of a liquid crystal monomer represented by the following formula (2) and a chiral agent represented by the following formula (5).

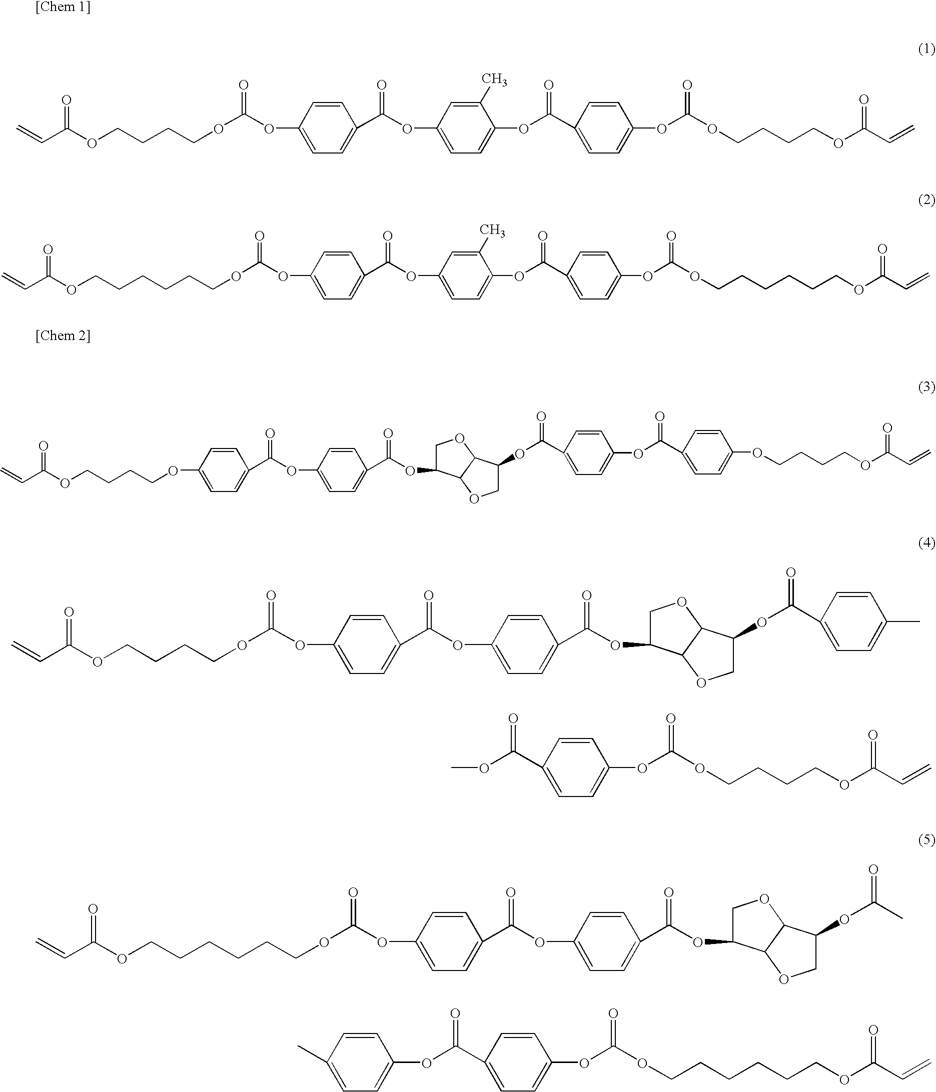

The above liquid crystal composition of which each of the negative C plates can be formed preferably further contains at least one of a polymerization initiator and a cross-linking agent (curing agent). The use of the polymerization initiator and/or the cross-linking agent (curing agent) can fix a cholesteric structure (cholesteric alignment) in which the liquid crystal material is formed in a liquid crystal state. Any appropriate and proper substance can be adopted as such polymerization initiator or cross-linking agent as long as an effect of the present invention can be obtained. The polymerization initiator and the cross-linking agent (curing agent) are as described in the above section B. One kind of a polymerization initiator or a cross-linking agent can be used alone, or two or more kinds of polymerization initiators or cross-linking agents can be used in combination. The content of the polymerization initiator or the cross-linking agent in the liquid crystal composition is preferably 0.1 to 10 wt %, more preferably 0.5 to 8 wt %, or most preferably 1 to 5 wt %. When the content is less than 0.1 wt %, the cholesteric structure is insufficiently fixed in some cases. When the content exceeds 10 wt %, the temperature range in which the above liquid crystal material shows a liquid crystal state narrows, so it becomes difficult to control a temperature upon formation of the cholesteric structure in some cases.

The above liquid crystal composition can further contain any appropriate and proper additive as required. Specific examples of the additive are as described in the above section B. One kind of those additives can be used alone, or two or more kinds of them can be used in combination.

In addition, in the present invention, each of polyamide, polyimide, polyester, polyetherketone, polyamideimide, and polyesterimide described in the paragraphs (0018) to (0072) of JP-A-2004-46065 can also be preferably used as a material of which each of the negative C plates is formed.

### D. Polarizer

The first polarizer and the second polarizer are typically arranged so that their absorption axes are perpendicular to each other. The direction of the absorption axis of the first polarizer can be appropriately set depending on purposes. For example, the direction of the absorption axis of the first polarizer arranged on the viewer side of the liquid crystal cell may be substantially parallel to the longitudinal direction of the liquid crystal cell (in this case, the direction of the absorption axis of the second polarizer is perpendicular to the longitudinal direction of the liquid crystal cell; see FIG. 2), or may be substantially perpendicular to the longitudinal direction of the liquid crystal cell (in this case, the direction of the absorption axis of the second polarizer is parallel to the longitudinal direction of the liquid crystal cell; see FIG. 3).

Any appropriate polarizer may be employed as the polarizer in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based alignment film formed of a polyene obtained from a dehydrated product of a polyvinyl alcohol, a dehydrochlorinated product of a polyvinyl chloride, or the like. Of those, a polarizer prepared by adsorbing a dichromatic substance such as iodine on a polyvinyl alcohol-based film and uniaxially stretching the film is particularly preferable because of high-polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface of the polyvinyl alcohol-based film or washing away of an antiblocking agent, but also provides an effect of preventing nonuniformity such as uneven coloring by swelling of the polyvinyl alcohol-based film. The stretching of the film may be performed after coloring of the film with iodine, may be performed during coloring of the film, or may be performed followed by coloring of the film with iodine. The stretching may be performed in an aqueous solution of boric acid or potassium iodide, or in a water bath.

### E. Protective Layer

Any appropriate film can be used as a protective layer (the first protective layer, the second protective layer, or the other layer). It is preferable that the protective layer be transparent protective film. Specific examples of a material used as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, an acrylic resin, and an acetate-based resin. Another example thereof includes an acryl-based, urethane-based, acrylic urethane-based, epoxy-based, or silicone-basedheat-curable resin or UV-curing resin. Still another example thereof includes a glassy polymer such as a siloxane-based polymer. Further, a polymer film described in JP 2001-343529 A (WO 01/37007) may also be used. More specifically, the film is formed of a resin composition containing a thermoplastic resin having a substituted or unsubstituted imide group on a side chain, and a thermoplastic resin having a substituted or unsubstituted phenyl group and a nitrile group on a side chain. A specific example thereof includes a resin composition containing an alternate copolymer of isobutene and N-methylmaleimide, and an acrylonitrile/styrene copolymer. The polymer film may be an extruded product of the above-mentioned resin composition, for example. Of those, TAC, a polyimide-based resin, a polyvinyl alcohol-based resin, a glassy polymer is preferable, and TAC is further preferable.

It is preferable that the protective layer be transparent and have no color. More specifically, the protective layer has a thickness direction retardation of preferably −90 nm to +90 nm, more preferably −80 nm to +80 nm, and most preferably −70 nm to +70 nm.

The protective layer has any appropriate thickness as long as the preferable thickness direction retardation can be obtained.

Specifically, the thickness of the protective film is preferably 5 mm or less, more preferably 1 mm or less, particularly preferably 1 to 500 μm, and most preferably 5 to 150 μm.

The protective layer arranged on the outer side of the polarizer (the opposite side of the optical compensation layer) may be subjected to hard coat treatment, antireflection treatment, anti-sticking treatment, antiglare treatment, and the like as required.

### F. Adhesion Layer

The first optical compensation layer and the first negative C plate can be arranged through a first adhesion layer (not shown). In addition, the second optical compensation layer and the second negative C plate can be arranged through a second adhesion layer (not shown). The use of the adhesion layers can prevent, for example, the shift of a relationship between the optical axes of the respective layers or damage to the respective layers due to friction between the respective layers upon incorporation of the liquid crystal panel in the present invention. In addition, the layers can: reduce the interfacial reflection of light between the layers; and improve a contrast upon use of the layers in an image display apparatus. Any appropriate and proper adhesion layer is selected as any one of those adhesion layers depending on purposes. Any appropriate and proper adhesive or pressure-sensitive adhesive is preferably used.

A typical example of an adhesive of which each of the above adhesion layers is formed is a curable adhesive. Typical examples of the curable adhesive include: a photocurable adhesive such as a ultraviolet curable adhesive; a moisture curable adhesive; and a heat curable adhesive. Specific examples of the heat curable adhesive include thermosetting resin-based adhesives each made of, for example, an epoxy resin, an isocyanate resin, or a polyimide resin. Specific examples of the moisture curable adhesive include isocyanate resin-based moisture curable adhesives. A moisture curable adhesive (in particular, an isocyanate resin-based moisture curable adhesive) is preferred. A moisture curable adhesive is excellent in ease of use because of the following reason: the adhesive reacts with, for example, moisture in the air or adsorbed water on the surface of an adherend, or an active hydrogen group of, for example, a hydroxyl group or a carboxyl group to cure, so the adhesive can be cured naturally by being left after the application of the adhesive. Further, there is no need for heating the adhesive to a high temperature for the curing of the adhesive, so an optical compensation layer and the like are not heated to high temperatures. As a result, the cracking or the like of each of an optical compensation layer and a negative C plate at the time of the lamination of the layer or the plate can be prevented even when the layer and the plate each have an extremely small thickness as in the case of the present invention because there is no worry about the contraction of each of the layer and the plate due to heating. In addition, a curable adhesive hardly expands even when the adhesive is heated after its curing. Therefore, the cracking or the like of each of an optical compensation layer and a negative C plate can be prevented even when the layer and the plate each have an extremely small thickness, and a liquid crystal panel to be obtained is used under high temperature conditions. It should be noted that the above term “isocyanate resin-based adhesive” is a generic name for a polyisocyanate resin-based adhesive and a polyurethane resin-based adhesive.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65 wt %, especially preferably 25 to 65 wt %, and most preferably 30 to 50 wt % in solid content. Any appropriate solvent may be used as the solvent to be used depending on the kind of the curable resin, and specific examples thereof include ethyl acetate, methyl ethyl ketone, methyl isobutyl ketone, toluene, and xylene. One kind of the solvent may be used alone, or two or more kinds of them may be used in combination.

An application amount of the adhesive may be appropriately set depending on purposes. For example, the application amount is preferably 0.3 to 3 ml, more preferably 0.5 to 2 ml, and most preferably 1 to 2 ml per area (cm²) of the optical compensation layer.

After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm.

Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus the Microhardness can be converted into Vickers hardness. Microhardness can be calculated from indentation depth and indentation load by using, for example, a thin-film hardness meter (trade name, MH4000 or MHA-400, for example) manufactured by NEC Corporation.

An acrylic pressure-sensitive adhesive using an acrylic polymer as a base polymer is preferably used as the above pressure-sensitive adhesive because the pressure-sensitive adhesive is particularly excellent in optical transparency, shows moderate wettability, moderate aggregability, and a moderate pressure-sensitive characteristic such as adhesiveness, and is excellent in, for example, weatherability and heat resistance. The suitable thickness of the pressure-sensitive adhesive is generally 1 to 100 μm, preferably 5 to 80 μm, or particularly preferably 10 to 50 μm.

### G. Method of Producing Liquid Crystal Panel

### G-1. Method of Producing Liquid Crystal Panel

According to another aspect of the present invention, a method of producing a liquid crystal panel is provided. In a preferred embodiment, the method of producing a liquid crystal panel includes the steps of: laminating the first polarizer on a surface of a first protective layer; attaching a first optical compensation layer to a surface of the first protective layer; attaching a first negative C plate to a surface of the first optical compensation layer, which is opposite to the first protective layer to obtain a first laminate; attaching a first negative C plate side of the first laminate to one surface of a liquid crystal cell;

laminating the second polarizer on a surface of a second protective layer; attaching a second optical compensation layer to a surface of the second protective layer; attaching a second negative C plate to a surface of the second optical compensation layer, which is opposite to the second protective layer to obtain a second laminate; and attaching a second negative C plate side of the second laminate to one surface of a liquid crystal cell. In the production method, the first negative C plate and the second negative C plate are disposed on the respective sides of the liquid crystal panel.

According to the production method, a liquid crystal panel shown in FIG. 1, for example, can be obtained. The order and the like of the above respective steps can be appropriately changed depending on purposes. For example, with regard to the step of laminating a polarizer, the polarizer may be laminated on a protective layer in advance, or laminated after any one of the step of forming and the step of laminating an optical compensation layer (negative C plate). Hereinafter, details on the respective steps will be described.

### G-2. Method of Forming Optical Compensation Layer

Hereinafter, a representative method of forming an optical compensation layer will be described. The application of the method is not limited to the first optical compensation layer, and the second optical compensation layer can also be formed by a similar method. A procedure of the representative method of forming an optical compensation layer is as described below. First, a liquid crystal material which forms an optical compensation layer is applied onto a base material, and the liquid crystal material is aligned on the base material. To be specific, it is only to prepare an application liquid by dissolving or dispersing the liquid crystal material in an appropriate solvent, and to apply the application liquid onto the surface of the base material subjected to an alignment treatment (described later). The liquid crystal material is aligned by treating the material at the temperature at which the material shows a liquid crystal phase depending on the kind of the used liquid crystal material. Such temperature treatment causes the liquid crystal material to take a liquid crystal state, and aligns the liquid crystal material in accordance with the direction in which the surface of the base material is aligned. Thus, an optical compensation layer is formed.

As the base material, any appropriate base material may be used as long as an appropriate optical compensation layer in the present invention can be obtained. As the above base material, any appropriate base material may be adopted. Specific examples include glass substrates, metal foils, and plastic sheets or plastic films. Note that an alignment film may be provided on the base material, or may not be provided. As the plastic film, any appropriate film may be adopted. Specific examples thereof include films formed of transparent polymers including: polyester-based polymers such as polyethylene terephthalate and polyethylene naphthalate; cellulose-based polymers such as diacetyl cellulose and triacetyl cellulose; polycarbonate-based polymers; and acrylic polymers such as polymethyl methacrylate. In addition, there are given films formed of transparent polymers including: styrene-based polymers such as polystyrene and an acrylonitrile-styrene copolymer; olefin-based polymers such as polyethylene, polypropylene, polyolefins each having a cyclic or norbornene structure, and an ethylene-propylene copolymer; vinyl chloride-based polymers, and amide-based polymers such as nylon and aromatic polyamides. Further, there are given films formed of transparent polymers such as an imide-based polymer, a sulfone-based polymer, a polyether sulfone-based polymer, a polyetherether ketone-based polymer, a polyphenylene sulfide-based polymer, a vinyl alcohol-based polymer, a vinylidene chloride-based polymer, a vinyl butyral-based polymer, an arylate-based polymer, a polyoxymethylene-based polymer, and an epoxy-based polymer, and blend substances thereof. Of those, preferred is a polyethylene terephthalate (PET) film.

The base material has a thickness of preferably 20 to 100 μm, more preferably 30 to 90 μm, or most preferably 30 to 80 μm. When the thickness falls in the range, the liquid crystal panel is imparted with a strength for supporting an extremely thin optical compensation layer in a laminating step, and operabilities such as sliding property and roll traveling property are appropriately maintained.

Any appropriate alignment treatment is used as an alignment treatment for the base material as long as an appropriate optical compensation layer of the present invention can be obtained. Examples of the alignment treatment include a rubbing treatment, an oblique vapor deposition method, a stretching treatment, alight alignment treatment, a magnetic field alignment treatment, and an electric field alignment treatment. Of those, the rubbing treatment is preferred. As the rubbing treatment, the base material is preferably rubbed after an alignment film of polyvinyl alcohol, polyimide, or the like is formed on the base material.

A method for the above rubbing treatment is preferably the following method: in a rubbing treatment step of rubbing the surface of a continuous substrate film with rubbing rolls, the above continuous substrate film is supported and conveyed by a conveying belt having a metal surface, multiple back-up rolls are provided so as to support the lower surface of the conveying belt supporting the above continuous substrate film and to be opposite to the above rubbing rolls, and a rubbing strength RS defined by the following equation (1) is set to preferably 800 mm or more, more preferably 850 mm or more, still more preferably 1,000 mm or more, or particularly preferably 2,200 mm or more:

RS=N·M(1+2πr·nr/v) (1)

where N represents the number of times of rubbing (number of rubbing rolls) (dimensionless quantity), M represents the indentation amount of each rubbing roll (mm), π represents a circle ratio, r represents the radius of each rubbing roll (mm), nr represents the number of revolutions of each rubbing roll (rpm), and v represents the rate at which the continuous substrate film is conveyed (mm/sec). It should be noted that r represents the radius of a rubbing roll including a raised fabric portion (mm) when a raised fabric is wound around the rubbing roll as will be described later.

According to the above method, (1) the multiple back-up rolls for supporting the lower surface of the conveying belt supporting and conveying the continuous substrate film are provided in subjecting the film to a rubbing treatment, so the film can be subjected to a rubbing treatment in a stable state even when the indentation amount of each rubbing roll is increased, (2) a uniform alignment characteristic (uniform optical characteristics) can be obtained by setting a value for the above parameter referred to as “rubbing strength” to a predetermined value or higher even when the continuous substrate film undergoes blocking, and (3) the continuous substrate film can be continuously subjected to a rubbing treatment according to a roll-to-roll mode, so the production of a liquid crystal panel can be realized at a low cost. When the position of each rubbing roll is changed with respect to the surface of the above continuous substrate film, the position at which the rubbing roll initially comes into contact with the surface of the continuous substrate film is defined as an origin (zero point). It should be noted that the amount by which the rubbing roll is indented from the above origin toward the continuous substrate film (amount by which the position of the rubbing roll is changed) is defined as the indentation amount of the term “indentation amount of each rubbing roll” in the above method. It should be noted that, when a raised fabric is wound around the rubbing roll as will be described later, the position at which the tip of the raised fabric wound around the rubbing roll initially comes into contact with the surface of the continuous substrate film is defined as an origin (zero point).

In the method for the above rubbing treatment, when multiple rod-like back-up rolls for supporting the lower surface of the conveying belt supporting and conveying the continuous substrate film are provided so as to be substantially parallel to each other in subjecting the film to a rubbing treatment, the flatness of the conveying belt supported by the back-up rolls easily improves. In this case, when a center distance between two adjacent back-up rolls is set to be less than 50 mm, the outer diameter of each of the back-up rolls must be necessarily reduced. In this case, when the rate at which the continuous substrate film is conveyed is assumed to be constant, each of the back-up rolls rotates at a higher speed at the time of a rubbing treatment than that in the case where the back-up rolls each have a large outer diameter, so a problem such as the deformation of the continuous substrate film supported by the conveying belt due to heat generated upon rotation of the rolls may occur. On the other hand, in the case where a center distance between two adjacent back-up rolls is set to be more than 90 mm, the following problem occurs: the flatness of the conveying belt reduces, so alignment unevenness occurs in the film, and the external appearance of the film is apt to deteriorate. Therefore, a center distance between two adjacent back-up rolls is set to be preferably 50 mm or more and 90 mm or less, or more preferably 60 mm or more and 80 mm or less in order that such problems may be avoided. With such preferred constitution, an additionally uniform alignment characteristic can be imparted to the continuous substrate film, and consequently, an optical compensation layer having additionally uniform optical characteristics can be formed.

In the case where the outer diameter (diameter) of each of the above back-up rolls is set to be less than 30 mm, when the rate at which the continuous substrate film is conveyed is assumed to be constant, each of the back-up rolls rotates at a higher speed at the time of a rubbing treatment than that in the case where the back-up rolls each have a large outer diameter, so a problem such as the deformation of the continuous substrate film supported by the conveying belt due to heat generated upon rotation of the rolls may occur. On the other hand, in the case where the outer diameter of each of the back-up rolls is set to be more than 80 mm, the following problem occurs: the flatness of the conveying belt reduces, so alignment unevenness occurs in the film, and the external appearance of the film is apt to deteriorate. Therefore, the outer diameter of each of the above back-up rolls is set to be preferably 30 mm or more and 80 mm or less, or more preferably 40 mm or more and 70 mm or less in order that such problems may be avoided.

In the present invention, a raised fabric is preferably wound around each of the above rubbing rolls. For example, any one of rayon, cotton, nylon, and a mixture of two or more of them is preferably used as the above raised fabric.

The above conveying belt has a thickness in the range of preferably 0.5 to 2.0 mm, or more preferably 0.7 to 1.5 mm with a view to imparting flexibility to the belt while preventing the belt from easily sagging.

Hereinafter, an example of the above rubbing method will be described with reference to the drawing.

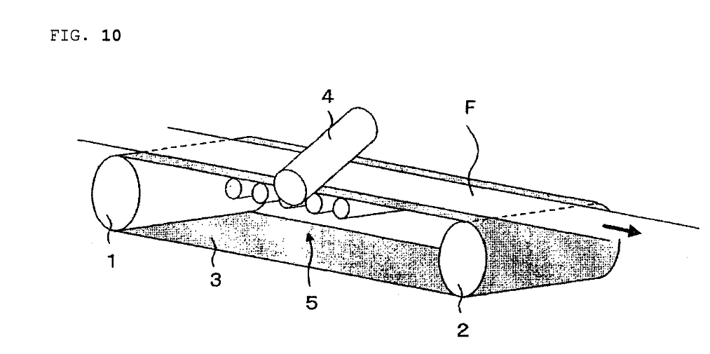

FIG. 10 is a perspective view showing the outline constitution of a rubbing treatment apparatus for carrying out the above method for a rubbing treatment. As shown in FIG. 10, the above rubbing treatment apparatus is provided with: driving rolls 1 and 2; an endless conveying belt 3 which is suspended between the driving rolls 1 and 2 and which supports and conveys a continuous substrate film F; a rubbing roll 4 provided above the conveying belt 3 so as to be capable of vertically ascending and descending; and multiple (five in this example) rod-like back-up rolls 5 provided so as to support the lower surface of the conveying belt 3 supporting the continuous substrate film F and to be opposite to the rubbing roll 4. It should be noted that a proper static eliminator, a proper dust arrester, or the like may be installed in front of or behind the rubbing treatment apparatus as required. In the present invention, the rubbing treatment apparatus is preferably provided with two to six back-up rolls.

The surface of the conveying belt 3 on the side where the continuous substrate film F is supported is a mirror-finished metal surface (the entirety of the conveying belt 3 may be made of a metal). Any one of various metal materials such as copper and steel can be used as such metal; stainless steel is preferably used in terms of strength, hardness, and durability. In order that adhesiveness between the conveying belt 3 and the continuous substrate film F may be secured, the extent to which the surface is mirror-finished is such that an arithmetic average surface roughness Ra (JIS B 0601 (version of the year 1994)) of the surface of the conveying belt 3 is preferably 0.02 μm or less, or more preferably 0.01 μm or less. In addition, the conveying belt 3 supporting the continuous substrate film F must be prevented from sagging in order that the film may be prevented from sagging. In view of the need for imparting some degree of flexibility to the conveying belt 3 in order that the conveying belt 3 may be suspended between the driving rolls 1 and 2 as well as the need for preventing the conveying belt 3 from sagging, the conveying belt 3 has a thickness in the range of preferably 0.5 to 2.0 mm, or more preferably 0.7 to 1.5 mm. In addition, in consideration of the tensile strength of the conveying belt 3 as well as the prevention of the sag of the conveying belt 3, a tension to be applied to the conveying belt 3 is in the range of preferably 0.5 to 20 kg-wt/mm², or more preferably 2 to 15 kg-wt/mm².

A raised fabric is preferably wound around the outer peripheral surface of the rubbing roll 4. It is sufficient to select the material, shape, and the like of the raised fabric appropriately depending on the material of the continuous substrate film F to be subjected to a rubbing treatment. In general, rayon, cotton, nylon, a mixture of two or more of them, or the like is applicable to the raised fabric. The rotation axis of the rubbing roll 4 according to this example is constituted so as to be capable of being inclined from the vertical direction (by an inclination angle of, for example, 0° to 50° with respect to the direction in which the continuous substrate film F is conveyed (direction indicated by the arrow in FIG. 10), that is, so as to be capable of being set at an appropriate axial angle with respect to the long side (longitudinal direction) of the continuous substrate film F. In addition, the rotation direction of the rubbing roll 4 can be appropriately selected depending on conditions for the rubbing treatment.

As described above, the multiple back-up rolls 5 are provided so as to support the lower surface of the conveying belt 3 supporting the continuous substrate film F and to be opposite to the rubbing roll 4. Providing the multiple back-up rolls 5 enables the continuous substrate film F to be subjected to a rubbing treatment in a stable state even when the rubbing roll 4 is indented with its rotation axis inclined, or the indentation amount of the rubbing roll 4 is increased.

In subjecting the continuous substrate film F to a rubbing treatment with the above rubbing apparatus, the continuous substrate film F wound around a predetermined roll (not shown) is supplied onto the conveying belt 3 through multiple conveying rolls (not shown). Then, the driving rolls 1 and 2 are rotated, whereby the upper portion of the conveying belt 3 moves in the direction indicated by the arrow in FIG. 10. In association with the movement, the continuous substrate film F is also conveyed along the conveying belt 3 to be subjected to a rubbing treatment with the rubbing roll 4.

In the rubbing treatment step of this example, a rubbing strength RS defined by the following equation (1) is set to preferably 800 nm or more, more preferably 850 nm or more, still more preferably 1,000 nm or more, or particularly preferably 2,200 nm or more:

RS=N·M(1+2πr·nr/v) (1).

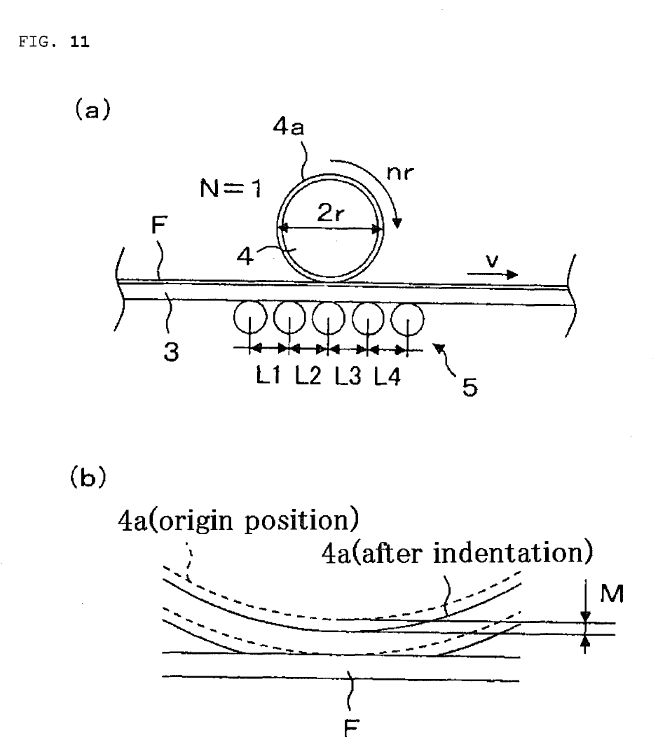

FIG. 11 are each a front view partially showing the rubbing treatment apparatus shown in FIG. 10. FIG. 11(a) is a front view showing the vicinity of the rubbing roll 4, and FIG. 11 (b) is an enlarged front view showing the vicinity of a portion where the rubbing roll 4 and the surface of the continuous substrate film F are in contact with each other. As described above, in the above equation (1), N represents the number of times of rubbing (corresponding to the number of the rubbing rolls 4, which is 1 in this example) (dimensionless quantity), M represents the indentation amount of the rubbing roll 4 (mm), π represents a circle ratio, r represents the radius of the rubbing roll 4 (including a raised fabric 4a) (mm), nr represents the number of revolutions of the rubbing roll (rpm), and v represents the rate at which the continuous substrate film F is conveyed (mm/sec). It should be noted that the indentation amount M of the rubbing roll is defined as follows: when the position of the rubbing roll 4 is changed with respect to the surface of the continuous substrate film F as shown in FIG. 11(b), the position at which the tip of the raised fabric 4a wound around the rubbing roll 4 initially contacts with the surface of the continuous substrate film F (position indicated by a broken line in FIG. 11(b)) is defined as an origin (zero point), and the amount in which the rubbing roll 4 is indented from the above origin toward the continuous substrate film F (amount in which the roll is indented as far as the position indicated by a solid line in FIG. 11(b)) is defined as the indentation amount M.

In the case where the rubbing strength RS is set to preferably 800 nm or more, more preferably 850 nm or more, still more preferably 1,000 nm or more, or particularly preferably 2,200 nm or more as described above, even when the continuous substrate film F undergoes blocking, a uniform alignment characteristic can be imparted to the film, and, consequently, an optical compensation layer having uniform optical characteristics can be produced. The amount of rubbing dust on the surface of the continuous substrate film F can be reduced by setting the upper limit of the rubbing strength RS to preferably 5,000 nm or less, more preferably 4,000 nm or less, or still more preferably 3,000 nm or less. As a result, with regard to a display characteristic, display quality can be improved because the number of bright points caused by the rubbing dust can be reduced. It should be noted that a material for the continuous substrate film F as an object to which the rubbing treatment according to this example is applied is not particularly limited as long as a function by which a liquid crystal compound applied onto the surface of the film can be aligned by subjecting the surface or an alignment film formed on the surface to a rubbing treatment is imparted to the film, and the above-mentioned continuous substrate film is applicable.

It should be noted that the other conditions for a rubbing treatment (respective parameters) can be appropriately selected as long as the rubbing strength RS is set to preferably 800 nm or more, more preferably 850 nm or more, still more preferably 1,000 nm or more, or particularly preferably 2,200 nm or more; the above rate v at which the continuous substrate film F is conveyed is, for example, in the range of preferably 1 to 50 m/min, or more preferably 1 to 10 m/min, the number of revolutions nr of the rubbing roll 4 is, for example, in the range of preferably 1 to 3,000 rpm, more preferably 500 to 2,000 rpm, or still more preferably 800 to 1,500 rpm, and the indentation amount M of the rubbing roll 4 is, for example, in the range of preferably 100 to 2,000 μm, or more preferably 100 to 1,000 μm.

It should be noted that a preferred constitution in this example is such that a center distance between two adjacent rolls of the multiple rod-like back-up rolls 5 provided so as to be substantially parallel to one another (any one of L1 to L4 of FIG. 11(a)) is set to preferably 50 mm or more and 90 mm or less, or more preferably 60 mm or more and 80 mm or less. Such constitution easily improves the flatness of the conveying belt 3 supported by the back-up rolls 5. In addition, each of the center distances L1 to L4 is set to 50 mm or more (the setting necessarily enlarges the outer diameter of each of the back-up rolls 5 to some extent), so none of the back-up rolls 5 rotates at a high speed at the time of a rubbing treatment, and a problem such as the deformation of the continuous substrate film F supported by the conveying belt 3 due to heat generated upon rotation of the rolls hardly occurs. Further, each of the center distances L1 to L4 is set to 90 mm or less, so a uniform alignment characteristic can be imparted to the continuous substrate film F without any reduction in flatness of the conveying belt 3. The outer diameter of each of the back-up rolls 5 is set to preferably 30 mm or more and 80 mm or less, or more preferably 40 mm or more and 70 mm or less. When the outer diameter of each of the back-up rolls 5 is set to 30 mm or more, none of the back-up rolls 5 rotates at a high speed at the time of a rubbing treatment, and a problem such as the deformation of the continuous substrate film F supported by the conveying belt 3 due to heat generated upon rotation of the rolls hardly occurs. In addition, when the outer diameter of each of the back-up rolls 5 is set to 80 mm or less, a uniform alignment characteristic can be imparted to the continuous substrate film F without any reduction in flatness of the conveying belt 3. The description has been given by taking the case where the back-up rolls 5 are each composed of a rod-like roll as an example of this example. However, the present invention is not limited to the above example, and a plate providedwithmultiple spherical bodies (bearing plate) is also applicable to the back-up rolls 5.

The direction of the alignment treatment refers to a direction at a predetermined angle with respect to the absorption axis of the polarizer when the polarizer is laminated. The alignment direction is substantially the same as the direction of the slow axis of an optical compensation layer to be formed. Thus, the predetermined angle is preferably +40° to +50° or −40° to −50°, more preferably +42° to +48° or −42° to −48°, particularly preferably +44° to +46° or −44° to −46°.

Any appropriate and proper solvent which may dissolve or disperse the liquid crystal material may be employed as the solvent. The kind of solvent to be used may be appropriately selected depending on the kind of liquid crystal material or the like. Specific examples of the solvent include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, butyl acetate, andpropyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, tetrahydrofuran, and dioxane; and carbon disulfide, ethyl cellosolve, butyl cellosolve, and ethyl cellosolve acetate. Of those, toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate are preferred. The solvents may be used alone or in combination.

A content of the liquid crystal material in the application liquid may be appropriately determined depending on the kind of liquid crystal material, the thickness of the target layer, and the like. To be specific, the content of the liquid crystal material is preferably 5 to 50 wt %, more preferably 10 to 40 wt %, and most preferably 15 to 30 wt %.

An application amount of the application liquid may be appropriately determined depending on a concentration of the application liquid, the thickness of the target layer, and the like. For example, when the concentration of the liquid crystal material is 20 wt % in the application liquid, the application amount is preferably 0.02 to 0.08 ml, more preferably 0.03 to 0.07 ml, and most preferably 0.04 to 0.06 ml per 100 cm² of the substrate.

Any appropriate and proper application method may be employed, and specific examples thereof include roll coating, spin coating, wire bar coating, dip coating, extrusion, curtain coating, and spray coating.

The liquid crystal material is aligned through treatment at a temperature at which the material shows a liquid crystal phase depending on the kind of the used liquid crystal material. Such temperature treatment causes the liquid crystal material to take a liquid crystal state, and aligns the liquid crystal material depending on the direction in which the surface of the substrate is aligned. Thus, the first optical compensation layer is formed.

A treatment temperature may be appropriately determined as described above depending on the kind of liquid crystal material. To be specific, the treatment temperature is preferably 40 to 120° C., more preferably 50 to 100° C., and most preferably 60 to 90° C. A treatment time is preferably 30 seconds or more, more preferably 1 minute or more, particularly preferably 2 minutes or more, and most preferably 4 minutes or more. The treatment time of less than 30 seconds may provide an insufficient liquid crystal state of the liquid crystal material. Meanwhile, the treatment time is preferably 10 minutes or less, more preferably 8 minutes or less, and most preferably 7 minutes or less. The treatment time exceeding 10 minutes may cause sublimation of additives.

When the liquid crystal monomer (polymerizable monomer and/or a cross-linking monomer) as described in the section B is used as the liquid crystal material, the layer formed through the application is preferably subjected to a polymerization treatment or a cross-linking treatment. The polymerization treatment allows the liquid crystal monomer to polymerize and to be fixed as a repeating unit of a polymer molecule. The cross-linking treatment allows the liquid crystal monomer to form a three-dimensional network structure and to be fixed as a part of a cross-linked structure. As a result, the alignment state of the liquid crystal material is fixed.

A specific procedure for the above polymerization treatment or cross-linking treatment can be appropriately selected depending on the kind of a polymerization initiator or cross-linking agent to be used. For example, when a photopolymerization initiator or a photo cross-linking agent is used, irradiation with light has only to be performed, when a ultraviolet polymerization initiator or a ultraviolet cross-linking agent is used, irradiation with ultraviolet light has only to be performed, and when a polymerization initiator or a cross-linking agent is used by heat, heating has only to be performed. The irradiation time period of light or ultraviolet light, the irradiation intensity of light or ultraviolet light, the total quantity of the irradiation of light or ultraviolet light, and the like can be appropriately set depending on the kind of the liquid crystal material, the kind of the substrate, the kind of alignment treatment, desired characteristics for the optical compensation layer, and the like. In a similar manner, the heat temperature, the heat time period, and the like can be appropriately set.

Next, the optical compensation layer formed on the base material is attached to a surface of the protective layer. For example, with regard to the first optical compensation layer, the first optical compensation layer formed on the base material is attached to the first protective layer. At this time, a first polarizer may be laminated in advance on a surface of the first protective layer, which is opposite to the first optical compensation layer. The method of producing a polarizer is as described in the section D.

As a method for attachment, an appropriate method can be adopted as long as effects of the present invention can be obtained. The first optical compensation layer is preferably transferred to the surface of the first protective layer. The method for the transfer is not particularly limited, and, for example, the first optical compensation layer supported by the base material is attached to the first protective layer through any appropriate adhesive or pressure-sensitive adhesive. Examples of the adhesive include those described in the section F. Finally, the base material is peeled off from the first optical compensation layer, whereby the lamination of the first optical compensation layer and the first protective layer is completed. The description has been given of the first optical compensation layer here. However, the second optical compensation layer can also be similarly attached to the surface of the second protective layer.

### G-3. Method of Forming Negative C Plate

Hereinafter, typical examples of a method of forming a negative C plate will be described. The application of each of those methods is not limited to the first negative C plate, and the second negative C plate can also be formed by a similar method. A procedure in a typical method of forming a negative C plate is as described below.

### G-3-1. Method of Forming Cholesteric Alignment Fixed Layer

First, description will be given by taking a method of forming a cholesteric alignment fixed layer as an example. Any appropriate and proper method can be adopted as the above formation method as long as a desired cholesteric alignment fixed layer can be obtained. A representative method of forming a cholesteric alignment fixed layer involves: applying a liquid crystal composition (including a liquid crystal material and a chiral agent) onto a substrate; and aligning the liquid crystal material in the liquid crystal composition on the substrate. To be specific, it is sufficient to prepare an application liquid by dissolving or dispersing the liquid crystal composition in a proper solvent, and to apply the application liquid onto the surface of the substrate subjected to a proper alignment treatment as required. The alignment of the liquid crystal material includes the steps of: subjecting the used liquid crystal material to a heat treatment so that the material shows cholesteric alignment; and subjecting the material to at least one of a polymerization treatment and a cross-linking treatment to fix the alignment of the liquid crystal material. Hereinafter, an additionally specific procedure for a method of forming a negative C plate when a liquid crystal composition is used will be described.

The viscosity of the above application liquid containing the liquid crystal composition may vary depending on the content of the above liquid crystal material and a temperature. For example, when the concentration of the liquid crystal material at nearly room temperature (20 to 30° C.) is 5 to 70 wt %, the viscosity of the application liquid is preferably 0.2 to 20 mPa·s, more preferably 0.5 to 15 mPa·s, or most preferably 1 to 10 mPa·s. To be additionally specific, when the concentration of the liquid crystal material is 30 wt %, the viscosity of the application liquid is preferably 2 to 5 mPa·s, or more preferably 3 to 4 mPa·s. When the viscosity of the application liquid is 0.2 mPa·s or more, the occurrence of a liquid flow due to the travelling of the application liquid can be prevented in an extremely favorable manner. In addition, when the viscosity of the application liquid is 20 mPa·s or less, a negative C plate having no thickness unevenness and having extremely excellent surface smoothness can be obtained, and, further, the application liquid is excellent in application property.

Next, the above application liquid containing the liquid crystal composition is applied onto the substrate so that a development layer is formed. Any appropriate and proper method (typically, a method involving fluidly developing the application liquid containing the liquid crystal composition) can be adopted as a method of forming the development layer. Specific examples thereof include roll coating, spin coating, wire bar coating, dip coating, extrusion, curtain coating, and spray coating. Of those, spin coating and extrusion coating are preferred in view of application efficiency.

An application amount of the above application liquid containing the liquid crystal composition may be appropriately determined depending on a concentration of the application liquid, the thickness of the target layer, and the like. For example, when the concentration of the liquid crystal material is 20 wt % in the application liquid, the application amount is preferably 0.03 to 0.17 ml, more preferably 0.05 to 0.15 ml, and most preferably 0.08 to 0.12 ml per 100 cm² of the substrate.

Any appropriate and proper substrate capable of aligning the liquid crystal material can be adopted as the above substrate. Representative examples of the substrate include various plastic films. Examples of a plastic for use in any such film include, but not particularly limited to, triacetylcellulose (TAC), a polyolefin such as polyethylene, polypropylene, or a poly(4-methylpentene-1)norbornene-based polyolefin, polyimide, polyimideamide, polyetherimide, polyamide, polyether ether ketone, polyetherketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyallylate, an acrylic resin, polyvinyl alcohol, polypropylene, a cellulose-based plastic, an epoxy resin, and a phenol resin. Alternatively, a product obtained by placing such plastic film or sheet as described above on the surface of, for example, a substrate made of a metal such as aluminum, copper, or iron, a ceramic substrate, or a glass substrate can also be used. Alternatively, a product obtained by forming an SiO₂ oblique evaporated film on the surface of the above substrate, or of the above plastic film or sheet can also be used. The substrate has a thickness of preferably 5 to 500 μm, more preferably 10 to 200 μm, or most preferably 15 to 150 μm. Such thickness can provide the substrate with sufficient strength, and hence can prevent the occurrence of a problem such as the rupture of the substrate at the time of the production of the liquid crystal panel. The surface of the substrate may be subjected to a proper alignment treatment as required.

Next, the above liquid crystal composition is subjected to a heat treatment so that the liquid crystal material is aligned to show a liquid crystal phase. The above liquid crystal material is provided with distortion and aligned to show a liquid crystal phase because the liquid crystal composition contains the chiral agent as well as the above liquid crystal material. As a result, the liquid crystal material shows a cholesteric structure (helical structure).

A temperature condition for the above heat treatment can be appropriately set depending the kind of the above liquid crystal material (specifically, the temperature at which the liquid crystal material shows liquid crystallinity). The treatment is preferably performed in the same manner as that described in the above section G-2.

Next, the alignment (cholesteric structure) of the liquid crystal material is fixed by subjecting the liquid crystal material to a polymerization treatment or a cross-linking treatment in a state where the above liquid crystal composition shows a cholesteric structure. To be additionally specific, performing the polymerization treatment causes at least one of the above liquid crystal material (polymerizable monomer) and the chiral agent (polymerizable chiral agent) to polymerize, and causes at least one of the polymerizable monomer and the polymerizable chiral agent to be fixed as a repeating unit of a polymer molecule. In addition, performing the cross-linking treatment causes at least one of the above liquid crystal material (cross-linking monomer) and the chiral agent to form a three-dimensional network structure, and causes at least one of the cross-linking monomer and the chiral agent to be fixed as part of a cross-linked structure. As a result, the alignment state of the liquid crystal material is fixed. It should be noted that a polymer or three-dimensional network structure formed by the polymerization or cross-linking of the liquid crystal material is “non-liquid crystalline”, and hence does not undergo any transition to a liquid crystal phase, a glass phase, or a crystalline phase owing to, for example, a temperature change peculiar to a liquid crystal molecule in a formed negative C plate. Therefore, no alignment change due to a temperature occurs. As a result, the formed negative C plate can be used as a high-performance negative C plate that is not influenced by a temperature. Further, the negative C plate can significantly suppress light leakage and the like because its wavelength range of selective reflection is optimized in the range of 100 nm to 350 nm.

A specific procedure for the above polymerization treatment or cross-linking treatment can be appropriately selected depending on the kind of a polymerization initiator or cross-linking agent to be used. For example, when a photopolymerization initiator or aphotoinitiator cross-linking agent is used, irradiationwith light has only to be performed, when a ultraviolet polymerization initiator or a ultraviolet cross-linking agent is used, irradiation with ultraviolet light has only to be performed, and when a polymerization initiator or a cross-linking agent is used by heat, heating has only to be performed. The irradiation time period of light or ultraviolet light, the irradiation intensity of light or ultraviolet light, the total quantity of the irradiation of light or ultraviolet light, and the like can be appropriately set depending on the kind of the liquid crystal material, the kind of the substrate, desired characteristics for the negative C plate, and the like. Ina similar manner, the heat temperature, the heat time period, and the like can be appropriately set depending on purposes.

Next, the negative C plate formed on the substrate is stuck to the surface of the optical compensation layer. Description will be given of, for example, the first negative C plate. The first negative C plate formed on the substrate is stuck to the surface of the first optical compensation layer. In this case, the negative C plate is stuck to the surface of the first optical compensation layer opposite to the first polarizer. The production method of the polarizer is as described in the above D section.

A proper method can be adopted as a method for the sticking as long as the effect of the present invention can be obtained. The first negative C plate is preferably transferred onto the surface of the first optical compensation layer. A method for the transfer is not particularly limited, and, for example, the first negative C plate supported by the substrate is stuck to the first optical compensation layer through the first adhesion layer. An example of the first adhesion layer is a layer described in the above section F. Finally, the above substrate is peeled from the above first negative C plate, whereby the lamination of the above first optical compensation layer and the above first negative C plate is completed. The description has been given of the first negative C plate here. However, the second negative C plate can also be similarly stuck to the surface of the second optical compensation layer.

Such typical example of a method of forming a negative C plate as described above involves the use of a liquid crystal monomer (such as a polymerizable monomer or a cross-linking monomer) as a liquid crystal material. In the present invention, a method of forming a negative C plate is not limited to such method as described above, and a method involving the use of a liquid crystal polymer is also permitted; provided that such method involving the use of a liquid crystal monomer as described above is preferred. The use of a liquid crystal monomer can result in the formation of an optical compensation layer having an additionally excellent optical compensation function and an additionally small thickness. To be specific, the use of a liquid crystal monomer facilitates the control of the wavelength range of selective reflection. Further, the viscosity and the like of the application liquid can be easily set, so the formation of a thin negative C plate can be facilitated, and the plate is extremely excellent in handleability. In addition, the surface flatness of a negative C plate to be obtained is additionally excellent. In addition, a liquid crystal monomer is more preferably used because the negative C plate is excellent in heat resistance.

G-3-2. Method of Forming Negative C Plate from Non-Liquid Crystalline Polymer

Next, the case where a negative C plate is formed by using a non-liquid crystalline polymer will be described. Any appropriate and proper method can be adopted as the above formation method as long as a desired negative C plate can be obtained. A typical method of forming a negative C plate involves: dissolving or dispersing a non-liquid crystalline polymer in a proper solvent to prepare an application liquid; applying the application liquid onto the surface of a substrate subjected to a proper alignment treatment as required; and drying the resultant under heat. Hereinafter, an additionally specific procedure for a method of forming a negative C plate when a non-liquid crystalline polymer is used will be described.

Examples of the non-liquid crystalline polymer include polymers described in the above section C, such as polyamide, polyimide, polyester, polyetherketone, polyamideimide, and polyesterimide. One kind of polymer may be used alone, or the polymers may be used as a mixture of two or more kinds of polymers having different functional groups such as a mixture of polyaryletherketone and polyamide, for example. Among the polymers, polyimide is particularly preferred because of excellent transparency, high alignment property, and high stretching property.

Examples of the solvent for coating the solution include, but are not particularly limited to, for example, halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol, varachlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycoldimethyl ether, propyleneglycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, and tetrahydrofuran; and carbon disulfide, ethyl cellosolve, and butyl cellosolve. Of those, methyl isobutyl ketone is preferred because it indicates high solubility with non-liquid crystal materials and does not corrode the substrate. The solvents may be used alone or in combination.

As the concentration of the above-mentioned non-liquid crystalline polymer in the above-mentioned coating solution, any appropriate concentration can be adopted as long as the above-mentioned negative C plate is obtained and coating can be performed. For example, the coating solution contains a non-liquid crystalline polymer in an amount of preferably 5 to 50 parts by weight, and more preferably 5 to 40 parts by weight with respect to 100 parts by weight of the solvent. The solution in such a concentration range has viscosity that makes coating easier.

The above-mentioned coating solution can further contain various additives such as a stabilizer, a plasticizer, and metals as required.

The above-mentioned coating solution can further contain other different resins as required. Examples of such other resins include various kinds of general-purpose resins, an engineering plastic, a thermoplastic resin, and a thermosetting resin. By using such resins together, a negative C plate having suitable mechanical strength and durability depending on the purpose can be formed. The kind and amount of the above-mentioned different resins added to the coating solution can be set appropriately depending on the purpose. For example, such resin can be added to the above-mentioned non-liquid crystalline polymer in an amount of preferably 0 to 50% by weight, and more preferably 0 to 30% by weight.

An application amount of the application liquid containing the liquid crystal composition may be appropriately determined depending on a concentration of the application liquid, the thickness of the target layer, and the like. For example, when the concentration of the liquid crystal material is 20 wt % in the application liquid, the application amount is preferably 0.03 to 0.17 ml, more preferably 0.05 to 0.15 ml, and most preferably 0.08 to 0.12 ml per 100 cm² of the substrate.

Any appropriate and proper substrate may be employed as the substrate, and representative examples thereof include the substrate described in the above section G-3-1.

Examples of the coating methods for the coating solution include spin coating, roll coating, flow coating, printing, dip coating, casting deposition, bar coating, and gravure printing. Further, in coating, a method of superimposing a polymer layer may also be employed as required.

After coating, for example, a solvent in the above solution is evaporated to be removed by drying such as natural drying, air drying, and heat drying (e.g., 60 to 250° C.), whereby a negative C plate is formed.

Next, the negative C plate formed on the substrate is stuck to the surface of an optical compensation layer. Details on the foregoing are as described in the above section G-3-1.

### G-4. Specific Production Procedure

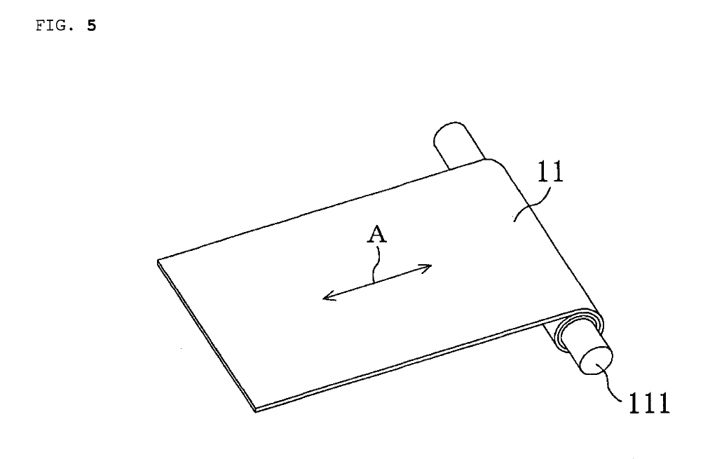

An example of a specific procedure for the production method of the present invention will be described with reference to FIGS. 5 to 9. In the liquid crystal panel of FIGS. 5 to 9, reference numerals 111, 112, 112′, 113, 114, 115, and 116 each are rolls for rolling films forming respective layers and/or a laminate.

In the following description of the specific procedure for the production method, an example of the liquid crystal panel of the present invention (such liquid crystal panel as shown in each of FIGS. 1 and 2) will be described. In the liquid crystal panel, a first polarizer is arranged on the viewer side of a liquid crystal cell, the direction of the absorption axis of the first polarizer is substantially parallel to the longitudinal direction of the liquid crystal cell, a second polarizer is arranged on the side opposite to the viewer side of the liquid crystal cell, and the direction of the absorption axis of the second polarizer is substantially perpendicular to the absorption axis of the first polarizer. In addition, the slow axis of a first optical compensation layer and the slow axis of a second optical compensation layer are substantially perpendicular to each other. It should be noted that the description will be given of the case where a negative C plate is composed of a cholesteric alignment fixed layer here; a substantially identical procedure is adopted even in the case where the negative C plate is formed of a non-liquid crystalline polymer.

First, a continuous polymer film being a raw material for a polarizer is prepared, and is subjected to coloring, stretching, and the like as described in the above section D. The continuous polymer film is subjected to continuous stretching in its longitudinal direction. In this way, as shown in a perspective view of FIG. 5, a continuous first polarizer 11 having an absorption axis in a longitudinal direction (stretching direction: direction of arrow A) is obtained.

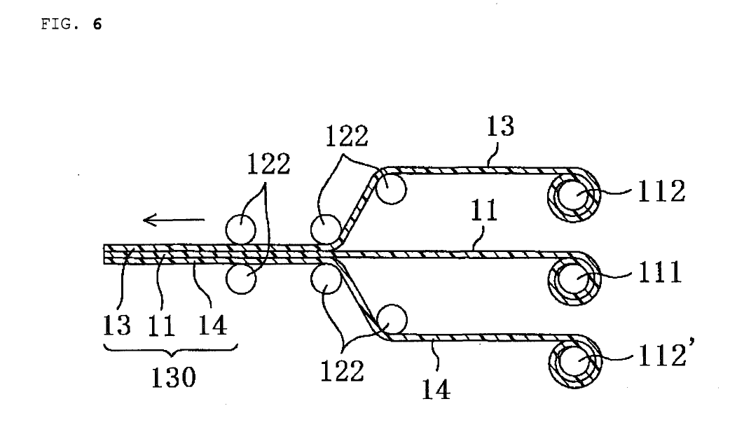

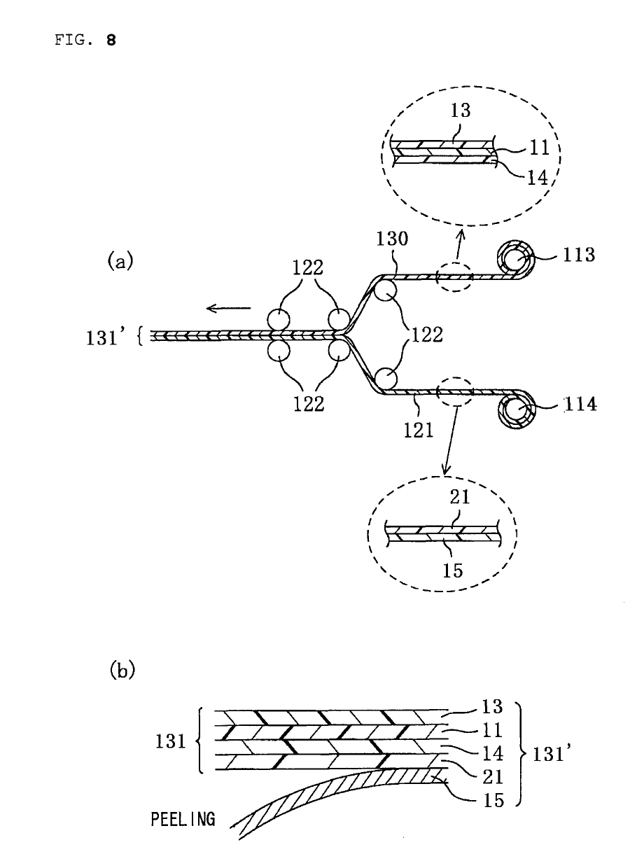

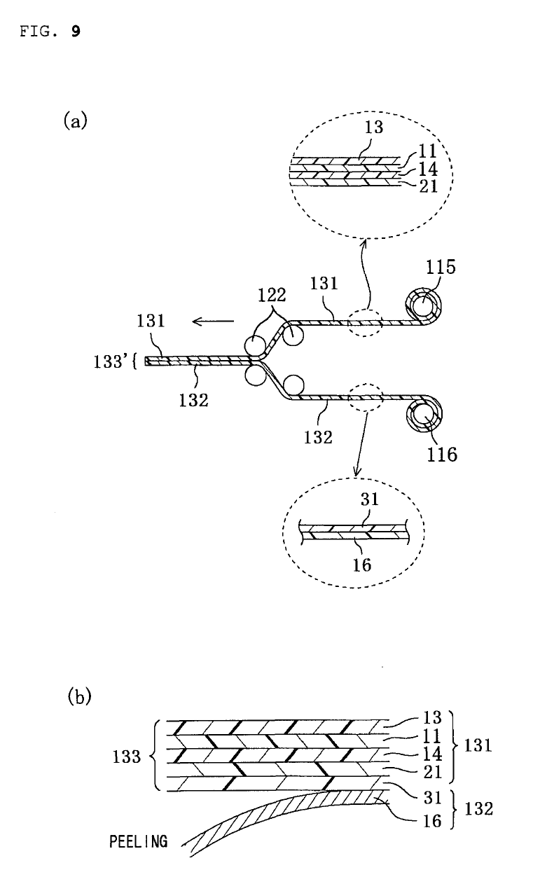

As shown in the schematic diagram of FIG. 6, a protective layer 13 formed in a long shape, the first polarizer 11, and a first protective layer 14 formed in a long shape are sent in the direction indicated by the arrow, and are attached to one another by using an adhesive or the like (not shown) with their lengthwise directions uniformized, whereby a first polarizing plate 130 is formed. It should be noted that a reference numeral 122 represents a guide roll for attaching films to each other (the same holds true for FIG. 8 and FIG. 9).

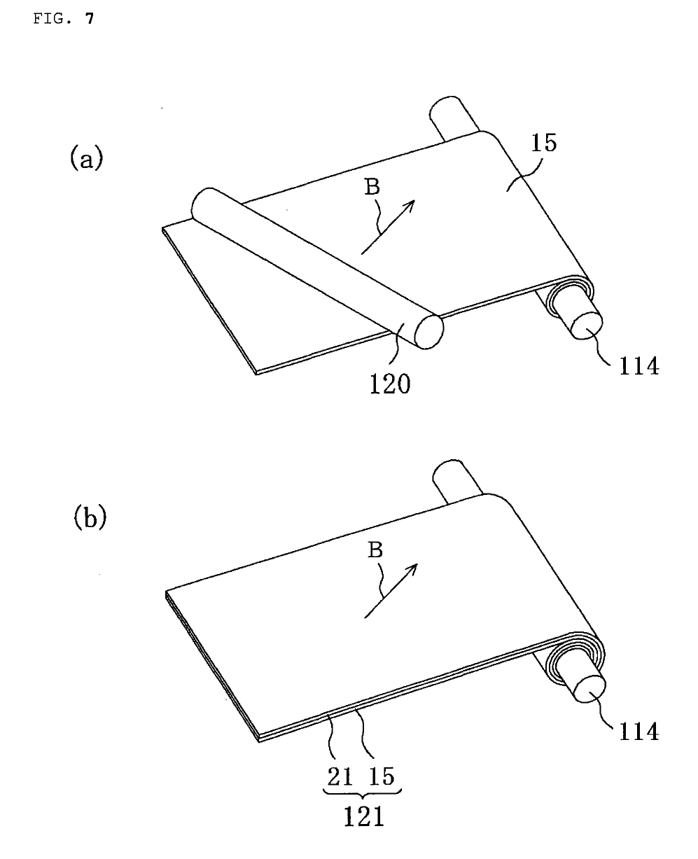

On the other hand, as shown in the perspective view of FIG. 7, a base material 15 formed in a long shape is prepared, and one surface thereof is subjected to rubbing treatment with the rubbing roll 120. In this case, the direction of the rubbing is, for example, a direction of 45° with respect to the lengthwise direction of the base material 15. Next, as shown in the perspective view of FIG. 7(b), on the base material 15 subjected to the rubbing treatment, the first optical compensation layer 21 is formed as described in the above section G-2. In the first optical compensation layer 21, a liquid crystal material is aligned along the rubbing direction, and thus a slow axis direction thereof is in a direction substantially identical to the rubbing direction of the base material 15 (direction of arrow B of FIG. 2).

Next, as shown in the schematic diagram of FIG. 8(a), a first polarizing plate 130 and a laminate 121 of the first optical compensation layer 21 and the base material 15 are sent in the direction indicated by an arrow, and are attached to one another by using an adhesive or the like (not shown) with their lengthwise directions uniformized, whereby a laminate 131′ is formed. Further, as shown in FIG. 8(b), the base material 15 is peeled off from the laminate 131′, whereby a laminate 131 (including the protective layer 13, the first polarizer 11, the first protective layer 14, and the first optical compensation layer 21) is formed.

Next, as shown in FIG. 9(a), the laminate 131 (including the protective layer 13, the first polarizer 11, the first protective layer 14, and the first optical compensation layer 21), and the laminate 132 of the first negative C plate 31 and the substrate 16 are delivered in the direction indicated by the arrow, and are stuck to each other through a first adhesive layer (not shown) with their longitudinal directions uniformized, whereby the laminate 133′ is formed. Further, as shown in FIG. 9(b), the substrate 16 is peeled from the laminate 133′, whereby the first laminate 133 (including the protective layer 13, the first polarizer 11, the first protective layer 14, the first optical compensation layer 21, and the first negative C plate 31) is obtained. As described above, according to the present invention, the first optical compensation layer having an extremely small thickness and the first negative C plate can be stuck to each other in the so-called roll-to-roll fashion, and hence the efficiency with which the liquid crystal panel is produced can be markedly improved. It should be noted that a second laminate can be produced in the same manner.

The side of the first negative C plate of the resultant first laminate is stuck to one surface of a liquid crystal cell. In this case, for example, an adhesive described in the above section F is used for the sticking. Next, as in the case of the first laminate, the side of the second negative C plate of the second laminate is stuck to the other surface of the liquid crystal cell. In this case, the first polarizer and a second polarizer are arranged so that their absorption axes are substantially perpendicular to each other.

In addition, the first optical compensation layer and a second optical compensation layer are arranged so that their slow axes are substantially perpendicular to each other.

The liquid crystal panel 100 of the present invention shown in FIG. 1 can be obtained through the above production steps.

According to the method of producing a liquid crystal panel of the present invention, the slow axis of the first optical compensation layer can be set in any appropriate direction, so a polarizer formed in a long shape (polarizing plate) which is stretched in a lengthwise direction (that is, having an absorption axis in the lengthwise direction) can be used. In other words, an optical compensation layer formed in a long shape, a protective layer formed in a long shape, and a polarizer formed in a long shape each of which is subjected to an alignment treatment to have a predetermined angle with respect to its lengthwise direction, can be continuously attached to one another with their lengthwise directions uniformi zed (in the so-called roll-to-roll fashion). Further, a negative C plate, an optical compensation layer, and polarizer, all of which are formed in long shapes can be continuously attached to one another with their lengthwise directions uniformized (in the so-called roll-to-roll fashion), whereby a laminate can be obtained with notably excellent production efficiency. As a result, the respective layers of the laminate do not show any variation in optical axial angle, whereby liquid crystal panels as products showing no variation in quality can be obtained. Further, a liquid crystal panel can be obtained at a low cost because no waste is produced owing to clipping. As a result of the foregoing, the liquid crystal panel of the present invention can be produced by the production method at a low cost while the respective layers do not show any variation in optical axial angle.

### H. Liquid Crystal Display Apparatus

The liquid crystal panel of the present invention may be used in a liquid crystal display apparatus. The liquid crystal display apparatus may be suitably used for various applications including: office automation (OA) devices such as a personal computer monitor, a laptop computer, and a copying machine; portable devices such as a cellular phone, a watch, a digital camera, a personal digital assistance (PDA), and a portable game machine; home appliances such as a video camera, a liquid crystal television, and a microwave; on-vehicle devices such as a back monitor, a car navigation system monitor, and a car audio; display devices such as a commercial information monitor; security devices such as a surveillance monitor; and nursing care and medical devices such as a nursing monitor and a medical monitor.

### EXAMPLES

Hereinafter, the present invention will be more specifically described by way of examples. However, the present invention is not limited to the examples. Methods of measuring characteristics in the examples are as described below.

### (1) Measurement of Retardation

Refractive indices nx, ny, and nz of a sample film were measured with an automatic birefringence analyzer (Automatic birefringence analyzer KOBRA-WPR manufactured by Oji Scientific Instruments), and an in-plane retardation Lnd and a thickness direction retardation Rth were calculated. A measurement temperature was 23° C., and a measurement wavelength was 590 nm.

### (2) Measurement of Contrast

A white image and a black image were displayed on a liquid crystal display apparatus, and a contrast at an azimuth angle of 0° to 360° and polar angle of 0° to 80° was measured by using “EZ Contrast 160D” (trade name, manufactured by ELDIM SA).

### Example 1

### Production of Polarizing Plate

A commercially available polyvinyl alcohol (PVA) film (manufactured by KURARAY CO., LTD.) was colored in an aqueous solution containing iodine and then uniaxially stretched 6 times between rolls of different speed ratios in an aqueous solution containing boric acid, whereby a continuous polarizer was obtained. In this case, the longitudinal direction of the polarizer was adapted to be the direction of the absorption axis of the polarizer. A commercially available TAC film manufactured by FUJIFILM Corporation was stuck to each of both surfaces of the polarizer through a PVA-based adhesive by employing the production method described in the above section G, whereby a polarizing plate having an entire thickness of 100 μm was obtained. Two polarizing plates of this kind were used, and were defined as a first polarizing plate and a second polarizing plate.

### <Formation of Optical Compensation Layer>

### 1. Preparation of Base Material

The surface of polyethylene terephthalate (PET) roll (having a thickness of 38 μm) was subjected to an alignment treatment with a rubbing cloth in a predetermined direction (+45° or) −45° with respect to the lengthwise direction of the base material, whereby an alignment base material was produced. The alignment treatment was performed under the following conditions: the number of times of rubbing (number of rubbing rolls) was 1, a rubbing roll radius r was 76.89 mm, and the other rubbing conditions including 11 kinds of conditions (a) to (k) as shown in Table 1.

TABLE 1

| | Number of | Indentation | Line speed | Rubbing |
|---|---|---|---|---|
| | revolutions | amount M | (mm/ | strength RS |
| | (rpm) | (mm) | minutes) | (mm) |
| Condition (a) | 1,500 | 0.1 | 5 | 873 |
| Condition (b) | 1,500 | 0.2 | 5 | 1,745 |
| Condition (c) | 1,500 | 0.3 | 5 | 2,618 |
| Condition (d) | 1,500 | 0.4 | 5 | 3,491 |
| Condition (e) | 1,500 | 0.5 | 5 | 4,363 |
| Condition (f) | 500 | 0.4 | 5 | 1,164 |
| Condition (g) | 750 | 0.4 | 5 | 1,745 |
| Condition (h) | 1,000 | 0.4 | 5 | 2,328 |
| Condition (i) | 1,250 | 0.4 | 5 | 2,910 |
| Condition (j) | 1,750 | 0.4 | 5 | 4,074 |
| Condition (k) | 2,000 | 0.4 | 5 | 4,656 |

An alignment substrate obtained under each of the conditions (a) to (k) shown in Table 1 was evaluated for rubbing stripe level, ratio at which foreign matter adhered, and number of bright points in black display.

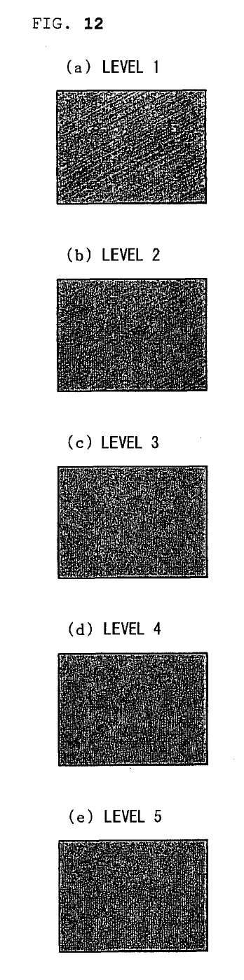

Each alignment substrate was evaluated for rubbing stripe level on the basis of the extent to which rubbing stripes observed in the external appearance photograph of the alignment substrate occurred. To be specific, the external appearance photograph of each alignment substrate was checked against each of the sample photographs shown in FIGS. 12(a) to (e), and the state closest to the external appearance photograph was selected. Cases corresponding to FIGS. 12(a) to (e) were defined as rubbing stripe levels 1 to 5, respectively. The rubbing stripe level 1 corresponds to the worst alignment state, and the rubbing stripe level 5 corresponds to the best alignment state.

With regard to the ratio at which foreign matter adhered, after the formation of a first optical compensation layer depending on an item 2 to be described later, the resultant products were photographed with a laser microscope (manufactured by KEYENCE CORPORATION, model: VK-8500), and the photographed images (black-and-white gray images each having 256 levels of gray) were binarized with an image processing software “adobe photoshop” at the same binarization level (levels of 151 or more of 256 levels of gray were each defined as a white color, and levels of 150 or less of 256 levels of gray were each defined as a black color). After that, a ratio (%) of an area occupied by white spots (corresponding to foreign matter adhering to a film) sampled by the binarization to the entire area of each image was calculated.

With regard to the number of bright points in black display, bright points per 1 m² were visually counted.

Table 2 shows the results of the evaluation.

TABLE 2

| | | Ratio at which | |
|---|---|---|---|
| | | foreign matter | Number of bright |
| | Rubbing stripe | adheres | points |
| | level | (%) | (/m²) |
| Condition (a) | 3 | 0.02 | 0 |
| Condition (b) | 4 | 0.03 | 0 |
| Condition (c) | 5 | 0.03 | 2 |
| Condition (d) | 5 | 0.12 | 8 |
| Condition (e) | 5 | 0.15 | 12 |
| Condition (f) | 3 | 0.03 | 1 |
| Condition (g) | 4 | 0.03 | 0 |
| Condition (h) | 5 | 0.03 | 2 |
| Condition (i) | 5 | 0.04 | 2 |
| Condition (j) | 5 | 0.36 | 32 |
| Condition (k) | 5 | 0.20 | 24 |

### 2. Formation of First Optical Compensation Layer

10.0 g of polymerizable liquid crystal material showing a nematic liquid crystal phase (liquid crystal monomer) (manufactured by BASF Aktiengesellschaft, trade name: Paliocolor LC242, represented by the following formula (1)), and 3 g of a photopolymerization initiator (manufactured by Ciba Specialty Chemicals, trade name: IRGACURE 907) for the polymerizable liquid crystal material were dissolved in 40 g of cyclopentanone, whereby an application liquid containing the liquid crystal material was prepared. The application liquid was applied onto the aligned base material produced as described above by using a bar coater, and the whole was heated and dried at 90° C. for 2 minutes, whereby the liquid crystal was aligned. The liquid crystal showed an extremely good alignment state under each of the conditions (c) to (e) and (h) to (k). The alignment of the liquid crystal was slightly disturbed under each of the conditions (a), (b), (f), and (g), but the disturbance caused no problem in practical use. The liquid crystal layer was irradiated with light of 1 mJ/cm² from a metal halide lamp in order that a polymerizable liquid crystal material might be polymerized and the alignment of the liquid crystal layer might be fixed. Thus, a first optical compensation layer was formed on the base material. The first optical compensation layer had a refractive index profile of nx>ny=nz, a thickness of 1.2 μm, and an in-plane retardation Re₁ of 140 nm.

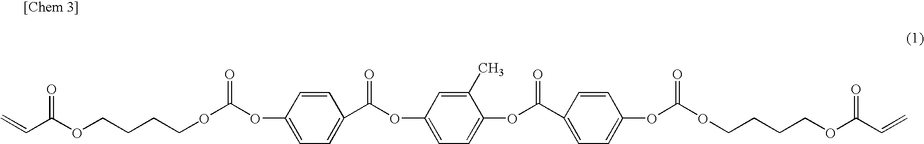

### 3. Formation of Second Optical Compensation Layer

A second optical compensation layer was formed on a base material in the same manner as in the above first optical compensation layer. The second optical compensation layer had a refractive index profile of nx>ny=nz, a thickness of 1.2 μm, and an in-plane retardation Re₂ of 140 nm.

### <Formation of Negative C Plate>

### 1. Formation of First Negative C Plate

90 parts by weight of a polymerizable liquid crystal material (liquid crystal monomer) showing a nematic liquid crystal phase (manufactured by BASF Aktiengesellschaft: trade name Paliocolor LC242: represented by the above formula (1)), 10 parts by weight of a chiral agent (manufactured by BASF Aktiengesellschaft: trade name Paliocolor LC756: represented by the following formula (4)), 5 parts by weight of a photopolymerization initiator (manufactured by Ciba Specialty Chemicals: trade name IRGACURE 907), and 30 parts by weight of methyl ethyl ketone were uniformly mixed, whereby an application liquid containing a liquid crystal composition was prepared. The application liquid containing the liquid crystal composition was applied onto a substrate (biaxially stretched PET film) by a spin coating method, and the whole was subjected to a heat treatment at 80° C. for 3 minutes. Next, the resultant was irradiated with ultraviolet light (20 mJ/cm², wavelength 365 nm) so that a polymerization treatment was performed. Thus, a continuous negative C plate (cholesteric alignment fixed layer) having a refractive index distribution of nx=ny>nz was formed on the substrate. The first negative C plate had a thickness of 2.4 μm, an in-plane retardation Re_{1C} of 0 nm, and a thickness direction retardation Rth_{1C} of 135 nm.

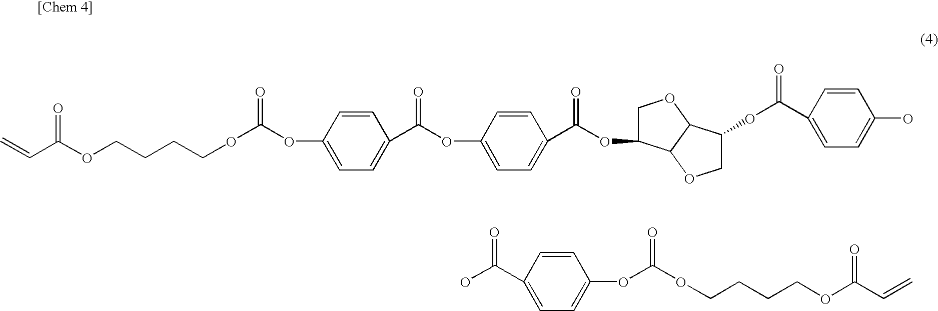

### 2. Formation of Second Negative C Plate

A second negative C plate (cholesteric alignment fixed layer) having a refractive index distribution of nx=ny>nz was formed on the substrate in the same manner as that of the above first negative C plate. The second negative C plate had a thickness of 2.4 μm, an in-plane retardation Re_{2C} of 0 nm, and a thickness direction retardation Rth_{2C} of 135 nm.

### <Production of Laminate>

### 1. Production of First Laminate

The obtained first polarizing plate obtained and the obtained first optical compensation layer were attached to each other through an isocyanate-based adhesive (having a thickness of 4 μm). After that, the base material supporting the first optical compensation layer was peeled off. At this time, the lamination was performed in such a manner that the slow axis of the first optical compensation layer defines an angle of 45° with respect to the absorption axis of the first polarizer. Next, the first negative C plate is attached to a side of the first optical compensation layer, which is opposite to the first polarizing plate through an isocyanate resin-based adhesion layer (having a thickness of 4 μm). The adhesion layer was cured by being heated at 50° C. for about 10 hours. Finally, the base material supporting the first negative C plate was peeled off, whereby a first laminate was obtained.

### 2. Production of Second Laminate

A second laminate was produced in the same manner as that of the above first laminate. In this case, a second optical compensation layer was laminated so that its slow axis might specify an angle of −45° with respect to the absorption axis of a second polarizer when viewed from the side of the second polarizer (the layer was laminated so that its slow axis might specify an angle of +45° with respect to the absorption axis of the second polarizer when viewed from the viewer side in FIG. 2). As a result, upon production of a liquid crystal panel, the slow axis of the second optical compensation layer was substantially perpendicular to the slow axis of the first optical compensation layer.

### <Production of Liquid Crystal Panel>

A liquid crystal cell according to a VA mode was taken out of a Play Station Portable manufactured by SONY, and the first laminate was stuck to the viewer side of the liquid crystal cell with an acrylic pressure-sensitive adhesive (thickness: 20 μm). In this case, the laminate was arranged so that the liquid crystal cell and the first negative C plate might face each other. Next, the second laminate was stuck to the backlight side of the liquid crystal cell with an acrylic pressure-sensitive adhesive (thickness: 20 μm). In this case, the laminate was arranged so that the liquid crystal cell and the second negative C plate might face each other. It should be noted that the first polarizer was arranged so that its absorption axis might be substantially parallel to the longitudinal direction of the liquid crystal cell, and might be substantially perpendicular to the absorption axis of the second polarizer. In addition, the first optical compensation layer was arranged so that its slow axis might be substantially perpendicular to the slow axis of the second optical compensation layer. As a result, a liquid crystal panel 1 as shown in FIG. 1 was obtained.

### <Production of Liquid Crystal Display Apparatus>

The liquid crystal panel 1 was incorporated into the original liquid crystal display apparatus, and the backlight of the resultant was turned on. 10 minutes after that, the contrast of the resultant was measured. The resultant characteristics, the thickness of the entirety of the liquid crystal panel, and the like are as shown in Table 3.

### Example 2

A 1-wt % polyvinyl alcohol solution was prepared by using polyvinyl alcohol having a saponification degree of 99% and a polymerization degree of 2,000 (manufactured by Nippon Synthetic Chemical Industry Co., Ltd.: N-300). Next, the obtained polyvinyl alcohol solution was applied onto the surface of polyethylene terephthalate (PET) roll (having a thickness of 38 μm), and was dried at 120° C. for 2 minutes, whereby an alignment film having a thickness of 70 nm was formed. Next, an alignment base material was produced having an alignment axis in a predetermined direction (+45° or)-45° with respect to its lengthwise direction by using a rubbing cloth. An optical compensation layer was formed on the alignment base material in the same manner as in Example 1. The optical compensation layer had a refractive index profile of nx>ny=nz, a thickness of 1.2 μm, and an in-plane retardation Re of 140 nm. Those two compensation layers were used, and the respective optical compensation layers were defined as first and second optical compensation layers.

A liquid crystal panel was produced in the same manner as in Example 1 except that the above optical compensation layer was used. The obtained liquid crystal panel was incorporated into a liquid crystal display apparatus, and the backlight thereof was turned on. 10 minutes after that, the contrast of the liquid crystal display apparatus was measured. The resultant characteristics, the thickness of the entirety of the liquid crystal panel, and the like are as shown in Table 3.

### Example 3

Polyimide synthesized from 2,2-bis(3,4-dicarboxyphenyl) hexafluoropropane dianhydride (6FDA) and 2,2′-bis(trifluoromethyl)-4,4′-diaminobiphenyl (TFMB) was dissolved in methyl isobutyl ketone (MIBK), whereby a 10 wt % polyimide solution was prepared. Next, the resultant polyimide solution was applied onto a triacetylcellulose film that had been already subjected to a saponification treatment, and was dried at 120° C. for 3 minutes, whereby a negative C plate was formed. The resultant negative C plate had a refractive index distribution of nx=ny>nz, a thickness of 3 μm, an in-plane retardation Re_{C} of 0 nm, and a thickness direction retardation Rth_{c} of 135 nm. Two negative C plates of this kind were used, and were defined as first and second negative C plates.

A liquid crystal panel was produced in the same manner as in Example 1 except that the above negative C plates were used. It should be noted that a triacetylcellulose film for supporting a negative C plate was peeled upon production of each of first and second laminates. The resultant liquid crystal panel was incorporated into a liquid crystal display apparatus, and the backlight of the resultant was turned on. 10 minutes after that, the contrast of the resultant was measured. The resultant characteristics, the thickness of the entirety of the liquid crystal panel, and the like are as shown in Table 3.

### Example 4

A liquid crystal panel was produced in the same manner as in Example 3 except that the first and second optical compensation layers obtained in Example 2 were used. The obtained liquid crystal panel was incorporated into a liquid crystal display apparatus, and the backlight thereof was turned on. 10 minutes after that, the contrast of the liquid crystal display apparatus was measured. The resultant characteristics, the thickness of the entirety of the liquid crystal panel, and the like are as shown in Table 3.

### Comparative Example 1

### Production of First and Second Optical Compensation Layers

A norbornene-based resin film (manufactured by ZEON CORPORATION: trade name ZEONOR: thickness 60 μm) was subjected to free-end, uniaxial stretching at a stretching temperature of 140° C. and a stretching ratio of 1.32, whereby a stretched film (λ/4 plate) was obtained. The stretched film had a refractive index distribution of nx>ny=nz, a thickness of 54 μm, and an in-plane retardation Re of 140 nm. Two films of this kind were used, and were defined as first and second optical compensation layers.

### <Production of First and Second Negative C Plates>

A norbornene-based resin film (manufactured by JSR: trade name ARTON: thickness 100 μm) was longitudinally stretched at 175° C. and a ratio of 1.27, and was then horizontally stretched at 176° C. and a ratio of 1.37, whereby a continuous negative C plate having a refractive index distribution of nx=ny>nz (and a thickness of 65 μm) was produced. The negative C plate had an in-plane retardation Re_{C} of 0 nm and a thickness direction retardation Rth_{C} of 110 nm. Two negative C plates of this kind were used.

### <Production of Laminate, Liquid Crystal Panel, and Liquid Crystal Display Apparatus>

A liquid crystal panel was produced in the same manner as in Example 1 except that: the above first and second optical compensation layers, and the above first and second negative C plates were used; the first optical compensation layer and the first negative C plate were stuck to each other with an acrylic pressure-sensitive adhesive; and the second optical compensation layer and the second negative C plate were stuck to each other with an acrylic pressure-sensitive adhesive. The resultant liquid crystal panel was incorporated into a liquid crystal display apparatus, and the backlight of the resultant was turned on. 10 minutes after that, the contrast of the resultant was measured. The resultant characteristics, the thickness of the entirety of the liquid crystal panel, and the like are as shown in Table 3.

### Comparative Example 2

A product with a trade name “ZEONOR” manufactured by ZEON CORPORATION as a norbornene-based film (having a thickness before stretching of 60 μm) was subjected to fixed-end, uniaxial stretching at 140° C. and a ratio of 1.5 in its longitudinal direction, whereby an optical compensation film (having a thickness after the stretching of 40 μm) was produced. The retardation of the resultant optical compensation film was measured. As a result, the film satisfied the relationship of nx>ny>nz, and had an in-plane retardation Re of 140 nm, a thickness direction retardation Rth of 217 nm, and an Nz coefficient (Nz=(nx−nz)/(nx−ny)) of 1.6. A liquid crystal panel having a polarizing plate used in Example 1, an optical compensation film of this kind, the liquid crystal cell used in Example 1, another optical compensation film of this kind, and another polarizing plate used in Example 1 in the stated order was produced. In this case, the respective layers were laminated with an acrylic pressure-sensitive adhesive. The liquid crystal panel was incorporated into a liquid crystal display apparatus, and the backlight of the resultant was turned on. 10 minutes after that, the contrast of the resultant was measured. The resultant characteristics, the thickness of the entirety of the liquid crystal panel, and the like are as shown in Table 3.

TABLE 3

| | Thickness of | Thickness of | |
|---|---|---|---|
| | entirety of | film portion | |
| | liquid crystal | except liquid | Region where |
| | panel | crystal cell | contrast is 50 |
| | (μm) | (μm) | or more |
| Example 1 | 1703 | 273 | Polar angle 35° |
| Example 2 | 1704 | 274 | Polar angle 35° |
| Example 3 | 1704 | 274 | Polar angle 35° |
| Example 4 | 1705 | 275 | Polar angle 35° |
| Comparative | 1966 | 536 | Polar angle 35° |
| Example 1 | | | |
| Comparative | 1784 | 354 | Polar angle 28° |
| Example 2 | | | |

### [Evaluation]

As is apparent from Examples 1 to 4, and Comparative Examples 1 and 2, the thickness of the entirety of a liquid crystal panel can be significantly reduced when first and second optical compensation layers are each a coating layer, and first and second negative C plates are each a coating layer. Comparison between Example 1 and Comparative Example 1 showed the following: Example 1 and Comparative Example 1 showed similar results in a region where a contrast was 50 or more, but the thickness of a film portion except a liquid crystal cell of Example 1 was about one half of that of Comparative Example 1, so the acquisition of a thin liquid crystal panel was attained in Example 1. Further, Example 1 shows a larger polar angle in a region where a contrast is 50 or more than that of Comparative Example 2. The foregoing shows that the liquid crystal panel of the present invention is excellent in contrast in an oblique direction, and can be reduced in thickness.

### INDUSTRIAL APPLICABILITY

The liquid crystal panel of the present invention is preferably applicable to various image display apparatuses (for example, a liquid crystal display apparatus).

1. A liquid crystal panel, comprising:
a liquid crystal cell;
a first polarizer disposed on one side of the liquid crystal cell;
a second polarizer disposed on another side of the liquid crystal cell;
a first optical compensation layer and a first negative C plate disposed between the first polarizer and the liquid crystal cell; and
a second negative C plate and a second optical compensation layer disposed between the liquid crystal cell and the second polarizer, wherein:
the first optical compensation layer is disposed between the first polarizer and the first negative C plate and the second optical compensation layer is disposed between the second negative C plate and the second polarizer;
the first optical compensation layer and the second optical compensation layer each comprise a coating layer functioning as a λ/4 plate, and each have a thickness of 0.3 to 3 μm; and
the first negative C plate and the second negative C plate each comprise a coating layer, and each have a thickness of 0.5 to 10 μm.

2. A liquid crystal panel according to claim 1, wherein the first negative C plate comprises a cholesteric alignment fixed layer.

3. A liquid crystal panel according to claim 1, wherein the first negative C plate comprises a coating layer including at least one kind of non-liquid crystal polymer selected from the group consisting of polyamide, polyimide, polyester, polyetherketone, polyamideimide, and polyesterimide.

4. A liquid crystal panel according to claim 1, wherein the second negative C plate comprises a cholesteric alignment fixed layer.

5. A liquid crystal panel according to claim 1, wherein the second negative C plate comprises a coating layer including at least one kind of non-liquid crystal polymer selected from the group consisting of polyamide, polyimide, polyester, polyetherketone, polyamideimide, and polyesterimide.

6. A liquid crystal panel according to claim 1, wherein a slow axis of the first optical compensation layer defines an angle of +40° to +50° or −40° to −50° with respect to an absorption axis of the first polarizer.

7. A liquid crystal panel according to claim 1, wherein a slow axis of the second optical compensation layer defines an angle of +40° to +50° or −40° to −50° with respect to an absorption axis of the second polarizer.

8. A liquid crystal panel according to claim 1, further comprising a protective layer on at least one side of the first polarizer.

9. A liquid crystal panel according to claim 1, further comprising a protective layer on at least one side of the second polarizer.

10. A liquid crystal panel according to claim 1, wherein the first optical compensation layer and the first negative C plate are disposed through a first adhesion layer.

11. A liquid crystal panel according to claim 1, wherein the second optical compensation layer and the second negative C plate are disposed through a second adhesion layer.

12. A liquid crystal panel according to claim 1, wherein the liquid crystal cell is a VA mode of a transmission function or a semi-transmission function.

13. A liquid crystal display apparatus, comprising the liquid crystal panel according to claim 1.
